(19) United States
(12) Patent Application Publication
(10) Pub. No.: US 2008/0021185 A1
(43) Pub. Date: Jan. 24, 2008

(54) Novel Polyvinyl Ester and Novel Polyvinylalcohol Copolymers

(75) Inventors: Jorg Schulte, Frankfurt (DE); Tim Dickner, Frankfurt (DE); Monika Bruckmann, Essen (DE); Jorg Schottek, Idstein (DE); Uwe Blank, Wiesbaden (DE)

Correspondence Address: CONNOLLY BOVE LODGE & HUTZ, LLP, P O BOX 2207, WILMINGTON, DE, 19899, US

(73) Assignee: Celanese Ventures GmbH, Frankfurt am Main (DE)

(21) Appl. No.: 10/566,424

(22) PCT Filed: Jul. 23, 2004
(86) PCT No.: PCT/EP04/08230

§ 371 Date: May 29, 2007

(30) Foreign Application Priority Data
Jul. 30, 2003 (DE) 10334656.2

(51) Int. Cl. C08F 218/02

(52) U.S. Cl. 526/330; 526/279

(57) ABSTRACT

The present invention relates to new polyvinyl polymers, to initiator systems for preparing them, to a process for preparing the polymers, and also to their use as an adhesive component, emulsifier, detergent, lubricant, coating component, for electrically insulating magnetic wires, for producing laminated glass sheets, as an adhesive primer, for textile coatings, as an additive for motor fuels, engine oils, concrete, and in papermaking, for producing water-soluble films and for preparing biodegradable and water-soluble polymers.

The present invention relates to initiator systems, to processes for preparing initiator systems, to block copolymers, to processes for preparing block copolymers, to processes for purifying block copolymers, to processes for chemically modifying block copolymers, and to uses of block copolymers.

Block copolymers are polymers whose molecules are composed of linearly linked blocks. A block is understood in this case to be a section of a polymer molecule which encompasses a plurality of identical repeating units and possesses at least one constitutional or configurative feature which differs from those of the adjacent sections (blocks). The blocks are joined to one another directly or by constitutional units which are not part of the blocks. Block copolymers may be synthesized from chemically different monomers or from chemically identical monomers, with a different tacticity in the blocks (source: Römpp Lexikon Chemie—Version 2.0, Stuttgart/New York: Georg Thieme Verlag 1999).

Many block copolymers have properties that are improved in comparison with those of homopolymers or polymer blends, such as improved processing properties and improved product properties, for example. With block copolymers, furthermore, it is possible to open up new fields of application. The polymer properties can be tailored through the choice and linking of the polymer blocks, and also through the chain lengths and, where appropriate, the tacticities, and can be adapted to the corresponding areas of application.

Preparing block copolymer based on polyvinyl acetate and polyvinyl alcohol has to date posed a great challenge. Apart from one example described in the literature (J. Huang, X. Huang, W. Hu, Macromol Chem. Phys. 1997, 198 2101-2109), polyvinyl acetate-polyethylene glycol block copolymers are unknown and have no commercial application so far. Polyvinyl alcohol-polyethylene glycol block copolymers are completely unknown. Other polyvinyl ester-polyalkylene glycol block copolymers and polyvinyl alcohol-polyalkylene glycol block copolymers, such as polyvinyl acetate-polypropylene glycol and polyvinyl alcohol-polypropylene glycol block copolymers, have not yet been described.

Polyvinyl esters are polymers obtainable from vinyl esters and containing the following moiety

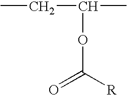

as the basic building block of the macromolecules. By far the greatest technical significance among them is possessed by the polyvinyl acetates (R═CH₃). Polyvinyl acetate is an important thermoplastic polymer and its uses include as an adhesive (component) base material for coatings, for packaging films, for the coating of paper and foods (sausage coatings and cheese coatings), as an additive to concrete, and as a base material for the preparation of polyvinyl alcohols and polyvinyl acetals (Römpp Lexikon Chemie—Version 2.0, Stuttgart/New York: Georg Thieme Verlag 1999).

Polyalkylene glycols are polymers which are obtainable from alkylene oxides and contain the following moiety

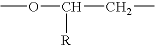

as the basic building block of the macromolecules. By far the greatest technical significance among them is possessed by the polyethylene glycols (R═H). Polyethylene glycol is an important industrial polymer and its uses include as a solubilizer, binder, consistency agent, emulsifier, dispersant, protective colloid, plasticizer or release agent for very different fields of use, as a binder for ceramic compositions, sizes, flocculants, as adhesive component, for reducing the flow resistance of aqueous liquids, as a starch substitute, and for producing films and sheets (Römpp Lexikon Chemie—Version 2.0, Stuttgart/New York: Georg Thieme Verlag 1999).

Polyvinyl alcohols are prepared industrially by hydrolysis of polyvinyl acetate and have the following moiety

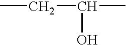

as basic building blocks of the macromolecules. Polyvinyl alcohols are employed principally for the following areas of application: as a protective colloid, emulsifier, binder, for protective skins and adhesives, finishes, sizes, metal-protection coatings, for preparing ointments and emulsions, water-soluble pouches and packing films, oil-, grease- and fuel-resistant hoses and seals, as an additive to shaving cream and soaps, as a thickener in pharmaceutical and cosmetic products, and as an artificial tear liquid. Polyvinyl alcohol can be spun to water-soluble fibres, known as vinal fibres, or foamed to form sponges. As reactive polymers, which can be given broad chemical variation (acetalization, esterification, etherification or crosslinking) via the secondary hydroxy groups, polyvinyl alcohols serve as base materials for the preparation, for example, of polyvinyl acetals (e.g. polyvinyl butyrals) (Römpp Lexikon Chemie—Version 2.0, Stuttgart/New York: Georg Thieme Verlag 1999).

Polyvinyl acetate-polyethylene glycol block copolymers have been preparable to date only by way of a photochemically induced free-radical polymerization (J. Huang, X. Huang, W. Hu, Macromol. Chem. Phys. 1997, 198, 2101-2109). This kind of reaction regime cannot be transferred to the industrial scale.

Surprisingly it has now been found that through the use of new initiator systems it is possible to obtain new polyvinyl ester block copolymers via a controlled free-radical polymerization (DE10238659; JP2003137917; M. Wakioka, K.-Y. Baek, T. Ando, M. Kamigaito, M. Sawamoto, Macromolecules 2002, 35, 330-333) by way of an operation which can be transferred to the industrial scale. Furthermore, from these polyvinyl ester block copolymers it is possible to prepare polyvinyl alcohol block copolymers which have outstanding suitability for use as water-soluble films, biodegradable and water-soluble polymers, detergents, an adhesive component and an emulsifier.

The present invention provides initiator systems, for preparing polyvinyl esters, comprising at least one initiator of formula I, Ia or Ib, at least one metal compound of formula II and where appropriate at least one additive of the formula III:

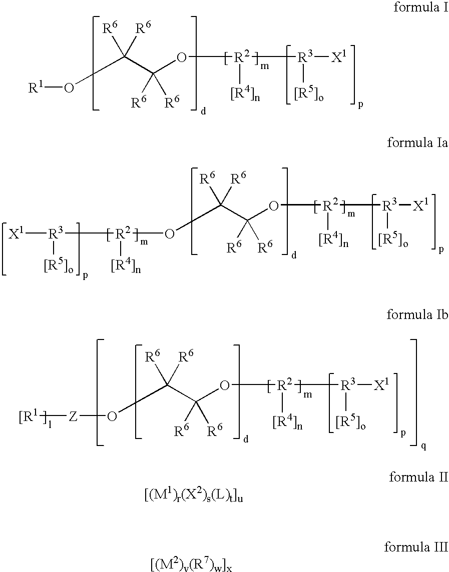

in which:
Z is a central atom and is an atom from groups 13 to 16 of the Periodic Table of the Elements, preferably carbon, silicon, nitrogen, phosphorus, oxygen or sulphur, more preferably carbon or silicon, or is an aromatic parent structure with at least four carbon atoms, in which one or more carbon atoms may be replaced by boron, nitrogen or phosphorus, with preferred aromatic or heteroaromatic parent structures deriving from benzene, biphenyl, naphthalene, anthracene, phenanthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, which where appropriate may also be substituted, or is a cyclic non-aromatic parent structure with at least three carbon atoms, which may also contain heteroatoms such as nitrogen, boron, phosphorus, oxygen or sulphur, preferred aliphatic parent structures being derivable from the cycloalkyl group, such as cyclopropyl, cyclobutyl, cyclopentyl, cyclohexyl, cycloheptyl, cyclooctyl or cyclononyl, or from the cycloheteroalkyl group, such as aziridine, azetidine, pyrrolidine, piperidine, azepane, azocane, 1,3,5-triazinane, 1,3,5-trioxane, oxetane, furan, dihydrofuran, tetrahydrofuran, pyran, dihydropyran, tetrahydropyran, oxepane, oxocane, or from the saccharides group, such as alpha-glucose or beta-glucose, and
X¹ is identical or different at each occurrence and is a halogen atom, preferably fluorine, chlorine, bromine or iodine, more preferably chlorine, bromine or iodine, and
R¹ is identical or different and is hydrogen or a C₁-C₂₀ group, and
R² is identical or different and is a bridging C₁-C₂₀ group between the central atom Z and the initiating unit [R³-X¹] or silicon or oxygen, and
R³ is identical or different and is carbon or silicon, and
R⁴ is identical or different and is a hydrogen atom or a C₁-C₂₀ group, and
R⁵ is identical or different and is hydrogen or a C₁-C₂₀ group,
R⁶ is identical or different and is hydrogen or a C₁-C₂₀ group, more preferably hydrogen or methyl, and
d is identical or different and is a whole natural number, and is a number between 5 and 100 000, and
l is a whole natural number and is zero, 1, 2, 3, 4, 5, 6, 7, 8, 9, 10, 11, 12, 13, 14, 15, 16, 17, 18, 19 or 20, and
m is identical or different at each occurrence and is a whole natural number, and is zero, 1, 2, 3, 4 or 5, and
n is identical or different at each occurrence and is a whole natural number, and is zero, 1, 2, 3, 4, 5, 6, 7, 8, 9, 10, 11, 12, 13, 14, 15, 16, 17, 18, 19 or 20, and
o is identical or different at each occurrence and is 1 or 2, and
p is identical or different at each occurrence and is a whole natural number, and is 1, 2, 3, 4 or 5, and
q is a whole natural number and is 3, 4, 5, 6, 7, 8, 9, 10, 11, 12, 13, 14, 15, 16, 17, 18, 19 or 20, and
M¹ is identical or different at each occurrence and is a transition metal from groups 3 to 12 of the Periodic Table of the Elements, preferably chromium, molybdenum, ruthenium, iron, rhodium, nickel, palladium or copper, more preferably iron or ruthenium, and
X² is identical or different at each occurrence and is oxygen or a halogen atom, more preferably fluorine, chlorine, bromine or iodine, and
L is identical or different at each occurrence and is a ligand, preferably a carbon-containing ligand such as methyl, phenyl, cymene, cumene, tolyl, mesityl, xylyl, indenyl, benzylidene, cyclopentadienyl or carbonyl, a nitrogen-containing ligand, such as triethylamine, tetramethylethylenediamine, pyridine, 2,2′-bipyridyl, substituted 2,2′-bipyridyl, 1,10-phenanthroline, phenylpyridin-2-yl-methylenamine, acetonitrile, substituted imidazolidine or terpyridyl, or a phosphorus-containing ligand, such as triphenylphosphine, tricyclohexylphosphine, bis(diphenylphosphino)ethane, bis(diphenylphosphino)propane or BINAP, and
r is identical or different at each occurrence and is a whole natural number, and is 1, 2, 3, 4 or 5, and
s is identical or different at each occurrence and is a whole natural number, and is zero, 1, 2, 3, 4 or 5, and
t is identical or different at each occurrence and is a whole natural number, and is zero, 1, 2, 3, 4 or 5, and
u is a whole natural number and is 1, 2, 3, 4 or 5, and
M² is identical or different and is an element from groups 1 to 15 of the Periodic Table of the elements, more preferably Li, Mg, Ti, B, Al, P or N, and
R⁷ is identical or different and is hydrogen, a halogen atom or a C₁-C₂₀ group, more preferably methoxy, ethoxy, n-propoxy or isopropoxy, and
v is identical or different and is a whole natural number, and is 1, 2, 3, 4, 5, 6, 7 or 8, and
w is identical or different and is a whole natural number, and is 1, 2, 3, 4, 5, 6, 7 or 8, and
x is a whole natural number and is 1, 2, 3, 4, 5, 6, 7 or 8.

In the context of the present invention, a C₁-C₂₀ group encompasses preferably the radicals C₁-C₂₀ alkyl, more preferably methyl, ethyl, n-propyl, isopropyl, n-butyl, isobutyl, sec-butyl, tert-butyl, n-pentyl, sec-pentyl, cyclopentyl, n-hexyl, cyclohexyl, n-octyl or cyclooctyl, C₁-C₂₀ alkenyl, more preferably ethenyl, propenyl, butenyl, pentenyl, cyclopentenyl, hexenyl, cyclohexenyl, octenyl or cyclooctenyl, C₁-C₂₀ alkynyl, more preferably ethynyl, propynyl, butynyl, pentynyl, hexynyl or octynyl, C₆-C₂₀ aryl, more preferably phenyl, biphenylyl, naphthyl or anthracenyl, C₁-C₂₀ fluoroalkyl, more preferably trifluoromethyl, pentafluoroethyl or 2,2,2-trifluoroethyl, C₆-C₂₀ aryl, more preferably phenyl, biphenylyl, naphthyl, anthracenyl, triphenylenyl, [1,1′,3′,1″]terphenyl-2′-yl, binaphthyl or phenanthrenyl, C₆-C₂₀ fluoroaryl, more preferably tetrafluorophenyl or heptafluoronaphthyl, C₁-C₂₀-alkoxy, more preferably methoxy, ethoxy, n-propoxy, isopropoxy, n-butoxy, isobutoxy, sec-butoxy or tert-butoxy, C₆-C₂₀ aryloxy, more preferably phenoxy, naphthoxy, biphenyloxy, anthracenyloxy, phenanthrenyloxy, C₇-C₂₀ arylalkyl, more preferably o-tolyl, m-tolyl, p-tolyl, 2,6-dimethylphenyl, 2,6-diethylphenyl, 2,6-diisopropylphenyl, 2,6-di-tert-butylphenyl, o-tert-butylphenyl, m-tert-butylphenyl, p-tert-butylphenyl, C₇-C₂₀ alkylaryl, more preferably benzyl, ethylphenyl, propylphenyl, diphenylmethyl, triphenylmethyl or naphthylmethyl, C₇-C₂₀ aryloxyalkyl, more preferably o-methoxyphenyl, m-phenoxymethyl, p-phenoxymethyl, C₁₂-C₂₀ aryloxyaryl, more preferably p-phenoxyphenyl, C₅-C₂₀ heteroaryl, more preferably 2-pyridyl, 3-pyridyl, 4-pyridyl, quinolinyl, isoquinolinyl, acridinyl, benzoquinolinyl or benzoisoquinolinyl, C₄-C₂₀ heterocycloalkyl, more preferably furyl, benzofuryl, 2-pyrrolidinyl, 2-indolyl, 3-indolyl, 2,3-dihydroindolyl, C₈-C₂₀ arylalkenyl, more preferably o-vinylphenyl, m-vinylphenyl, p-vinylphenyl, C₈-C₂₀ aryl alkynyl, more preferably o-ethynylphenyl, m-ethynylphenyl or p-ethynylphenyl, C₂ -C₂₀ group containing heteroatoms, more preferably carbonyl, benzoyl, oxybenzoyl, benzoyloxy, acetyl, acetoxy or nitrile it being possible for one or more C₁-C₂₀ groups to form a cyclic system.

In the context of the present invention a bridging C₁-C₂₀ group is preferably Cl-C₂₀ alkyl, more preferably methylene, ethylene, propylene, butylene, pentylene, cyclopentylene, hexylene or cyclohexylene, C₁-C₂₀ alkenyl, more preferably ethenyl, propenyl, butenyl, pentenyl, cyclopentenyl, hexenyl or cyclohexenyl, C₁-C₂₀ alkynyl, more preferably ethynyl, propynyl, butynyl, pentynyl or hexynyl, C₁-C₂₀ aryl, more preferably o-phenylene, m-phenylene or p-phenylene, C₁-C₂₀ group containing heteroatoms, more preferably carbonyl, oxycarbonyl, carbonyloxy, carbamoyl or amido.

Illustrative examples, but not examples restricting the invention, of compounds of the formula I are as follows:

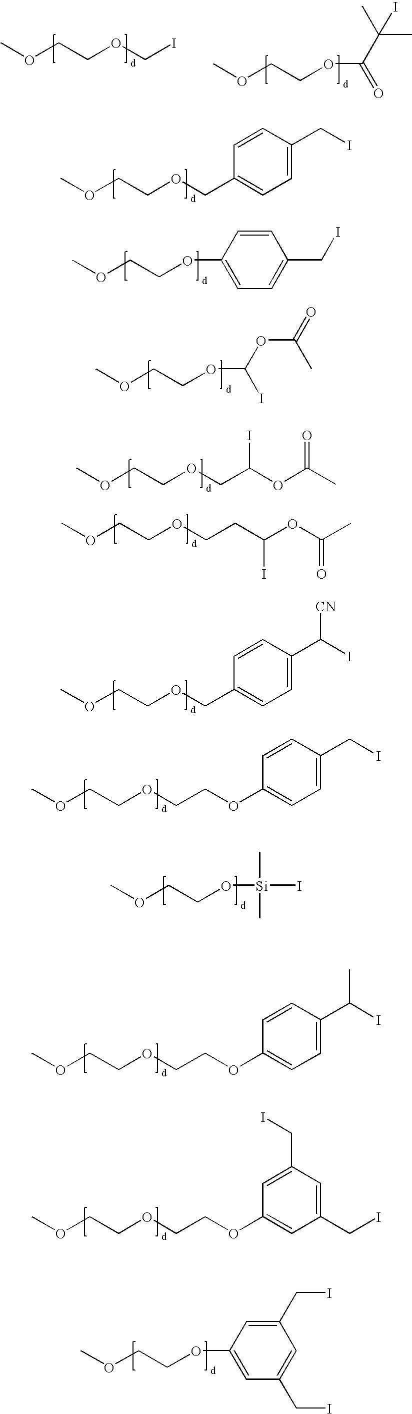

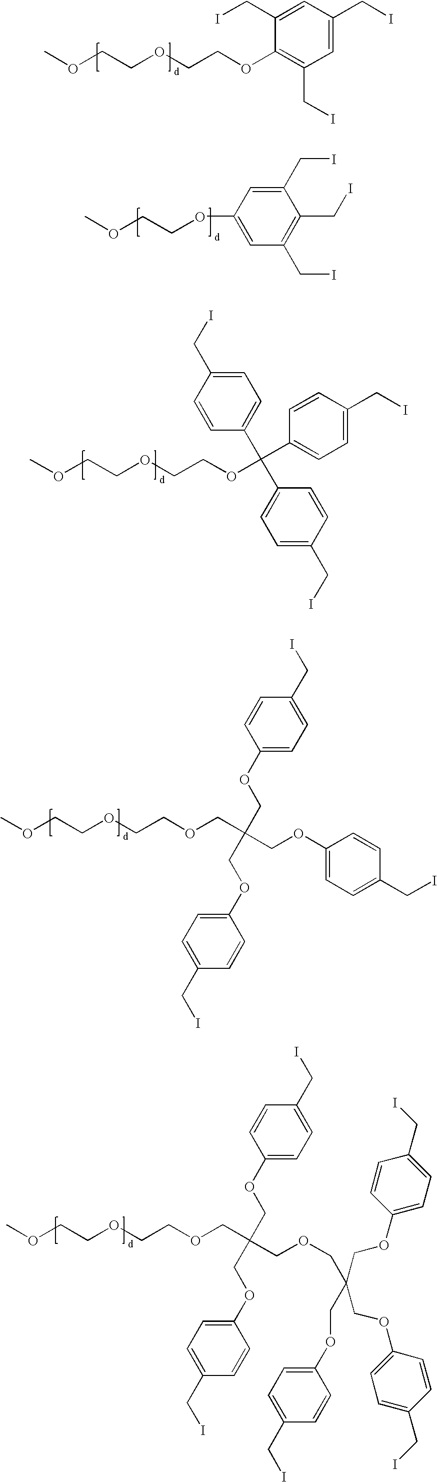

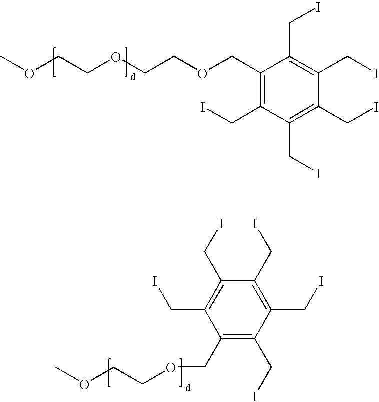

in which d is as defined above,

Illustrative examples, but not restricting the invention, of compounds of the formula Ia are as follows:

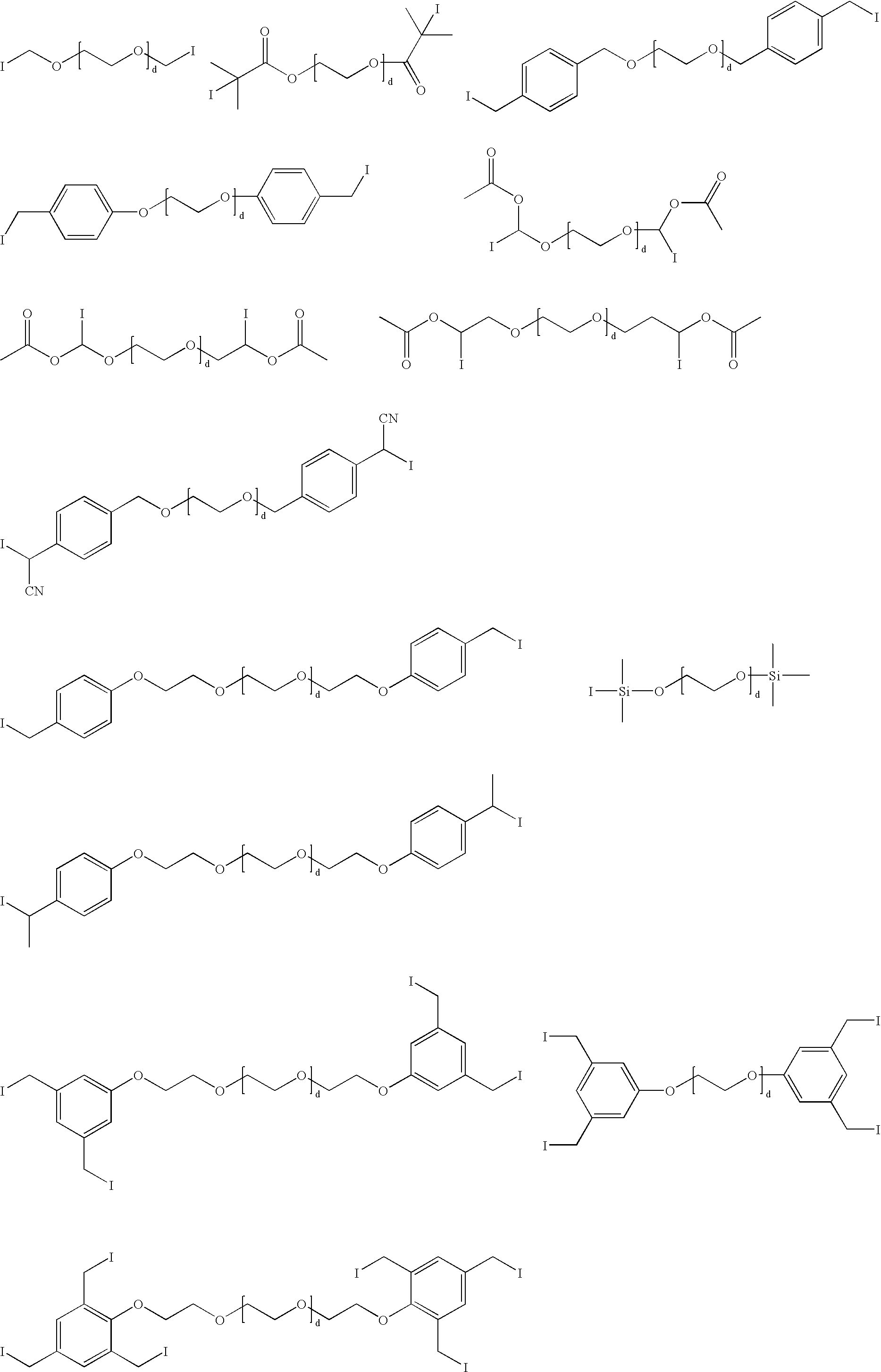

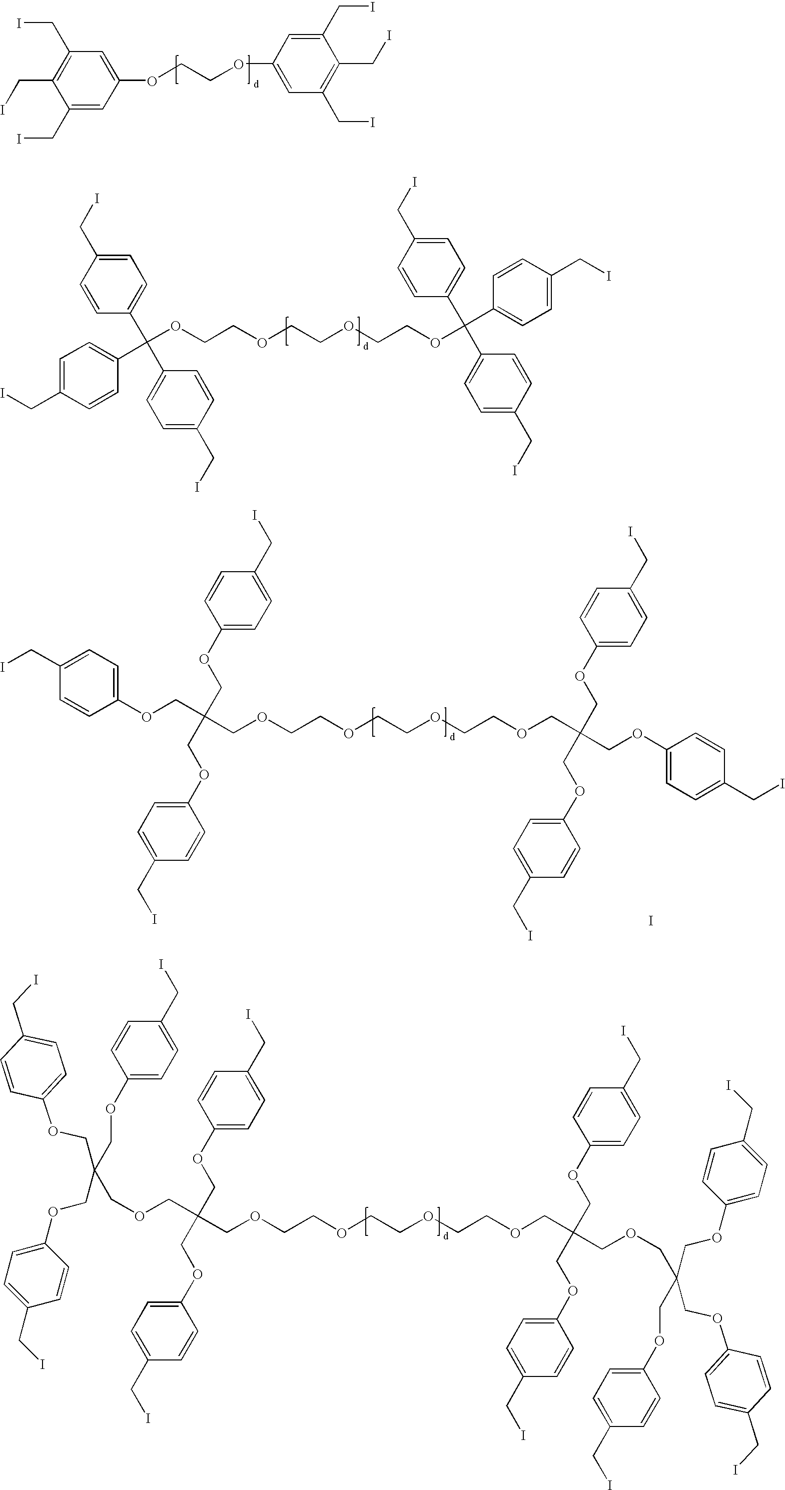

in which d is as defined above.

Illustrative examples, but not restricting the invention, of compounds of the formula Ib are as follows:

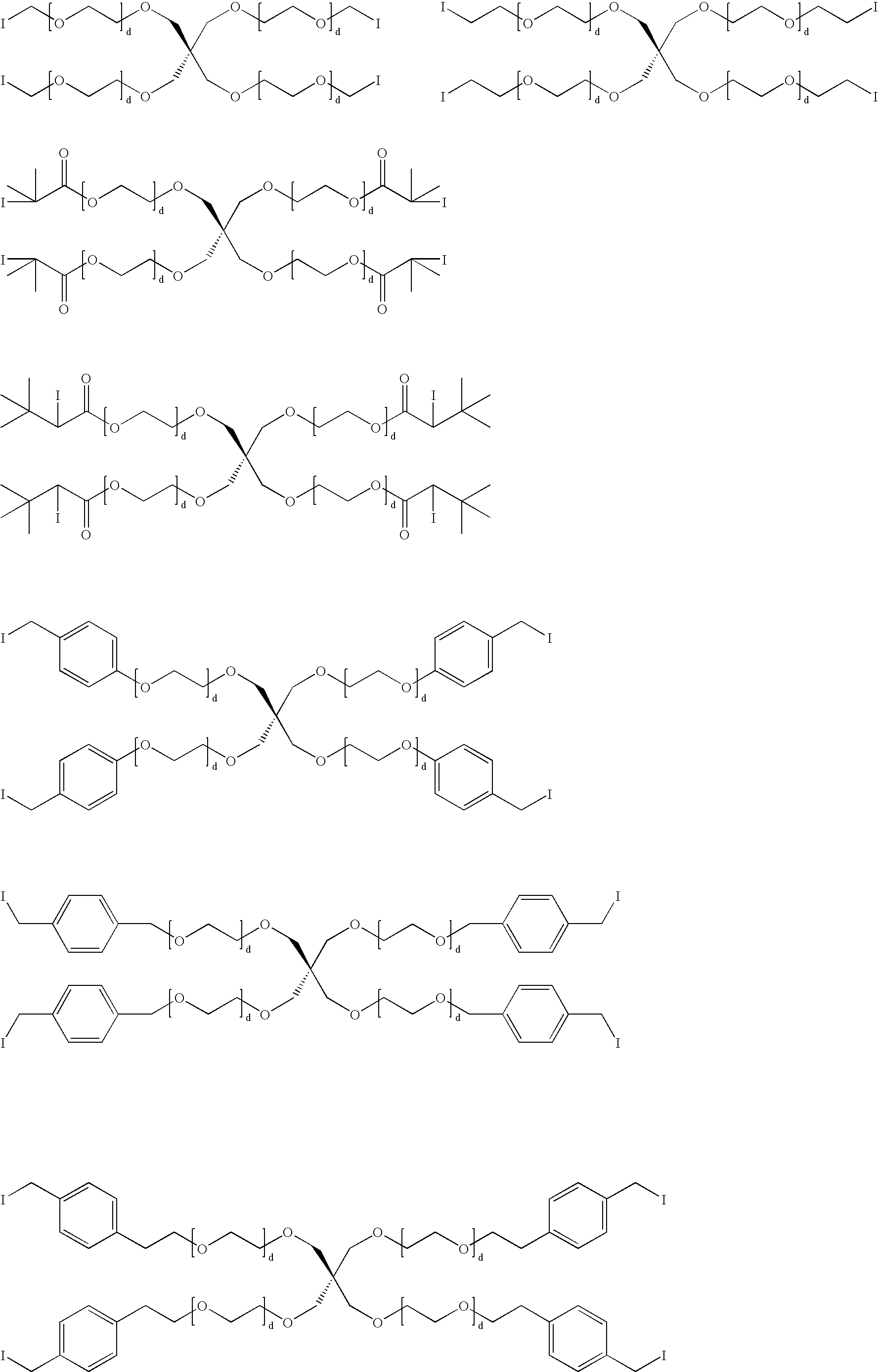

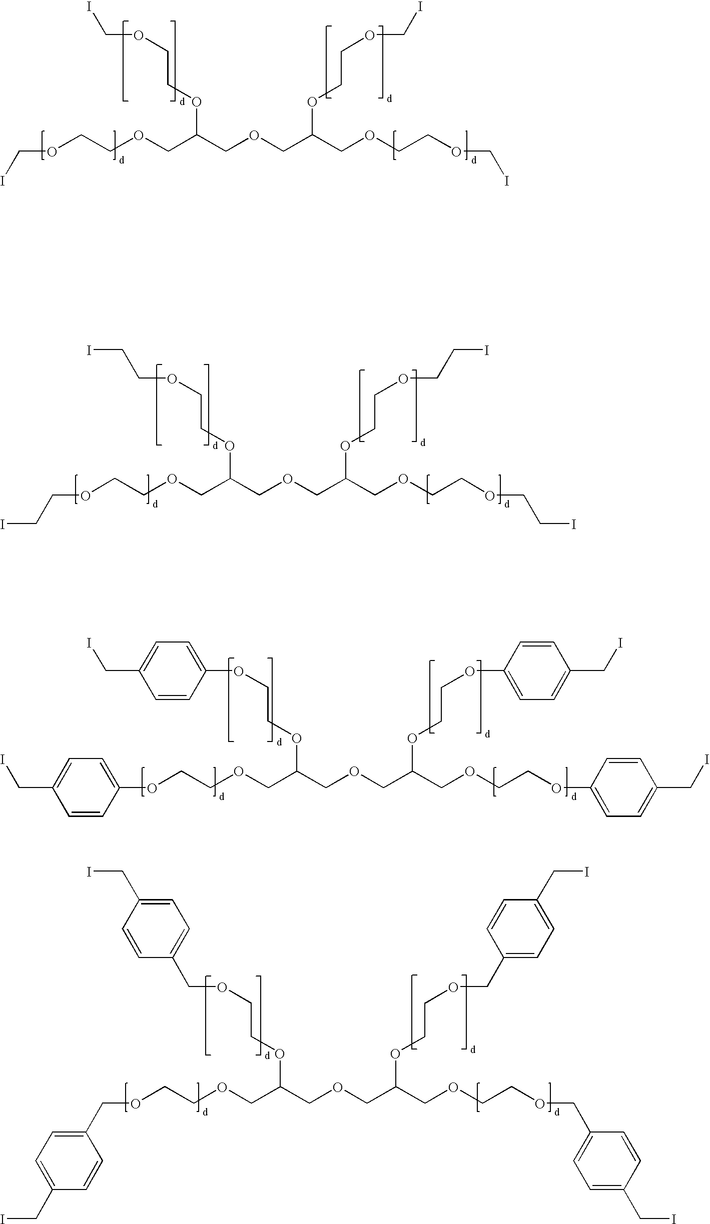

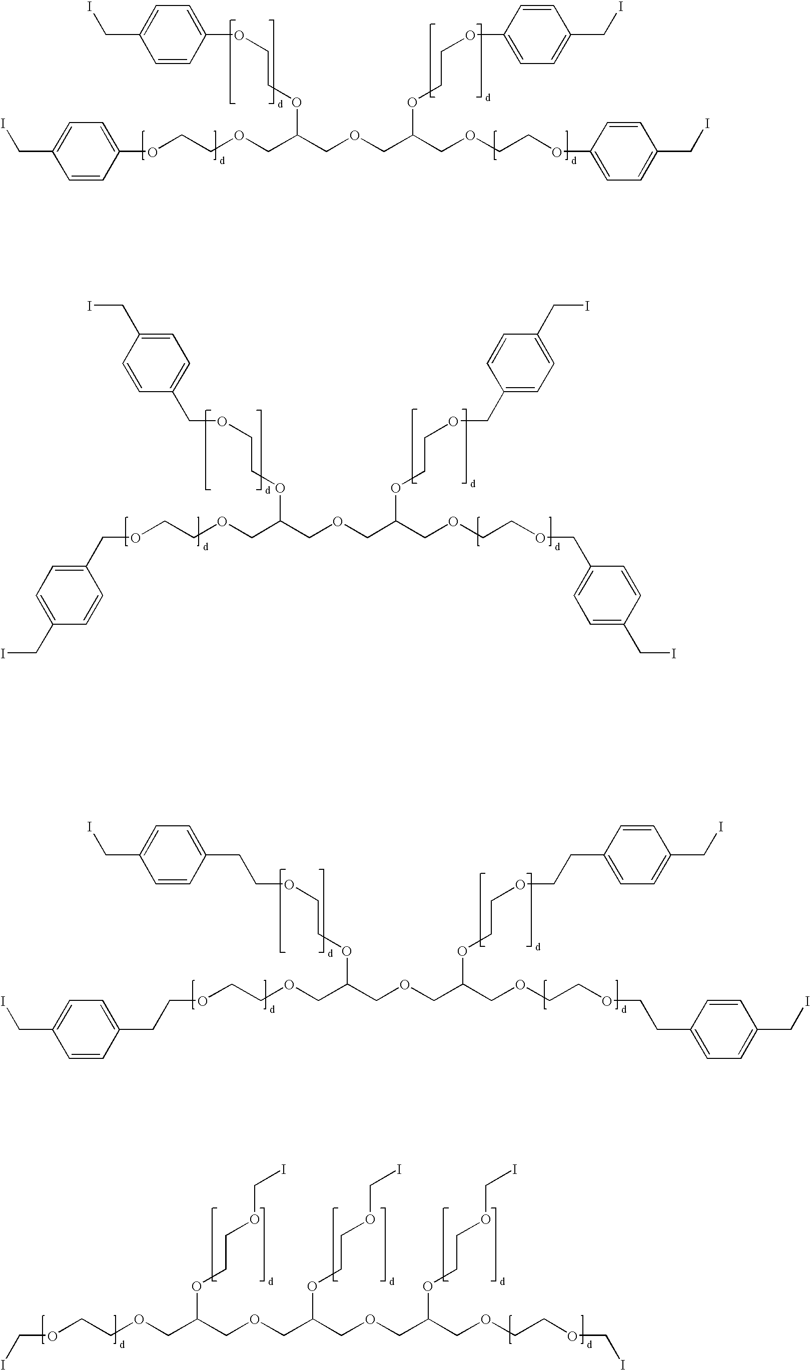

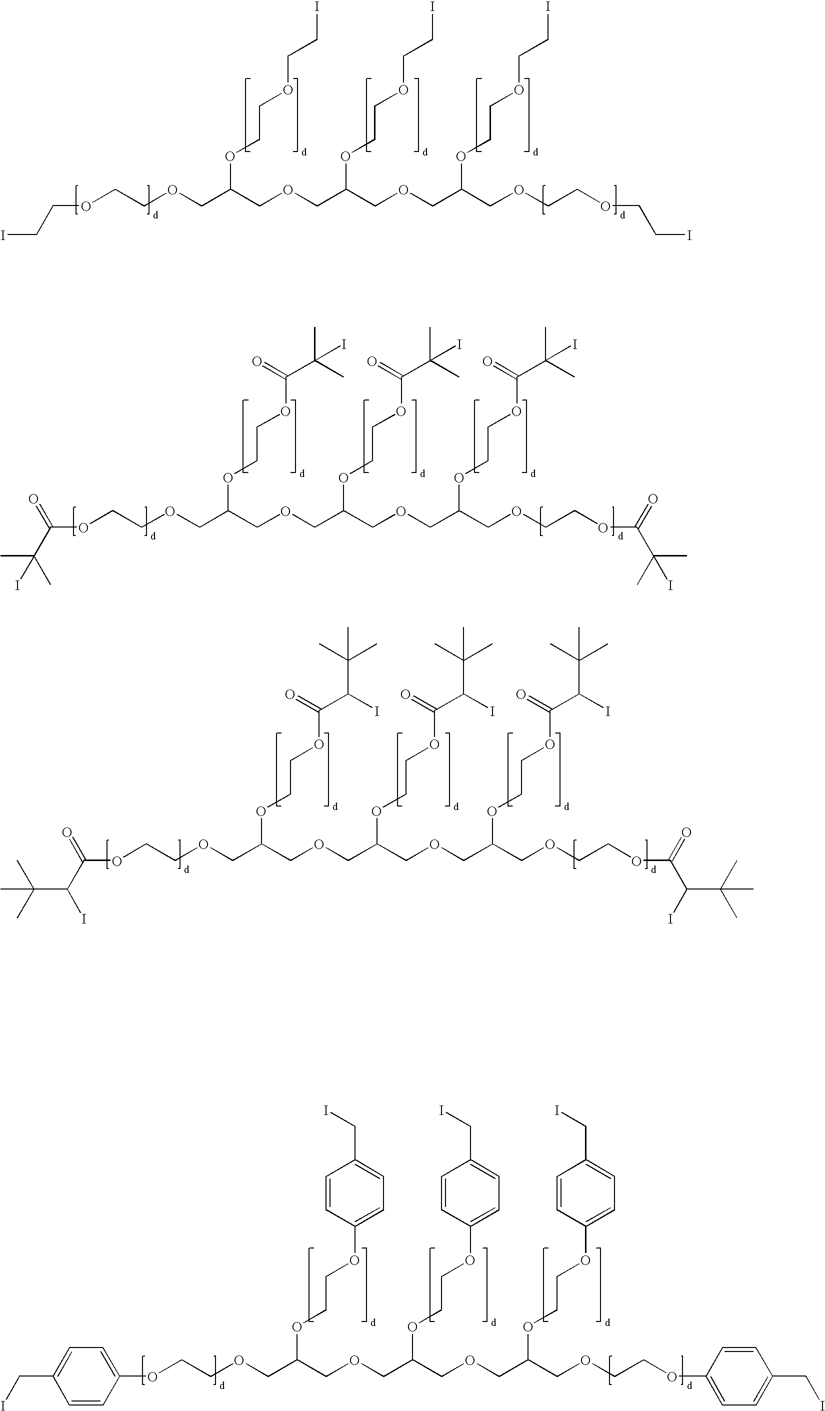

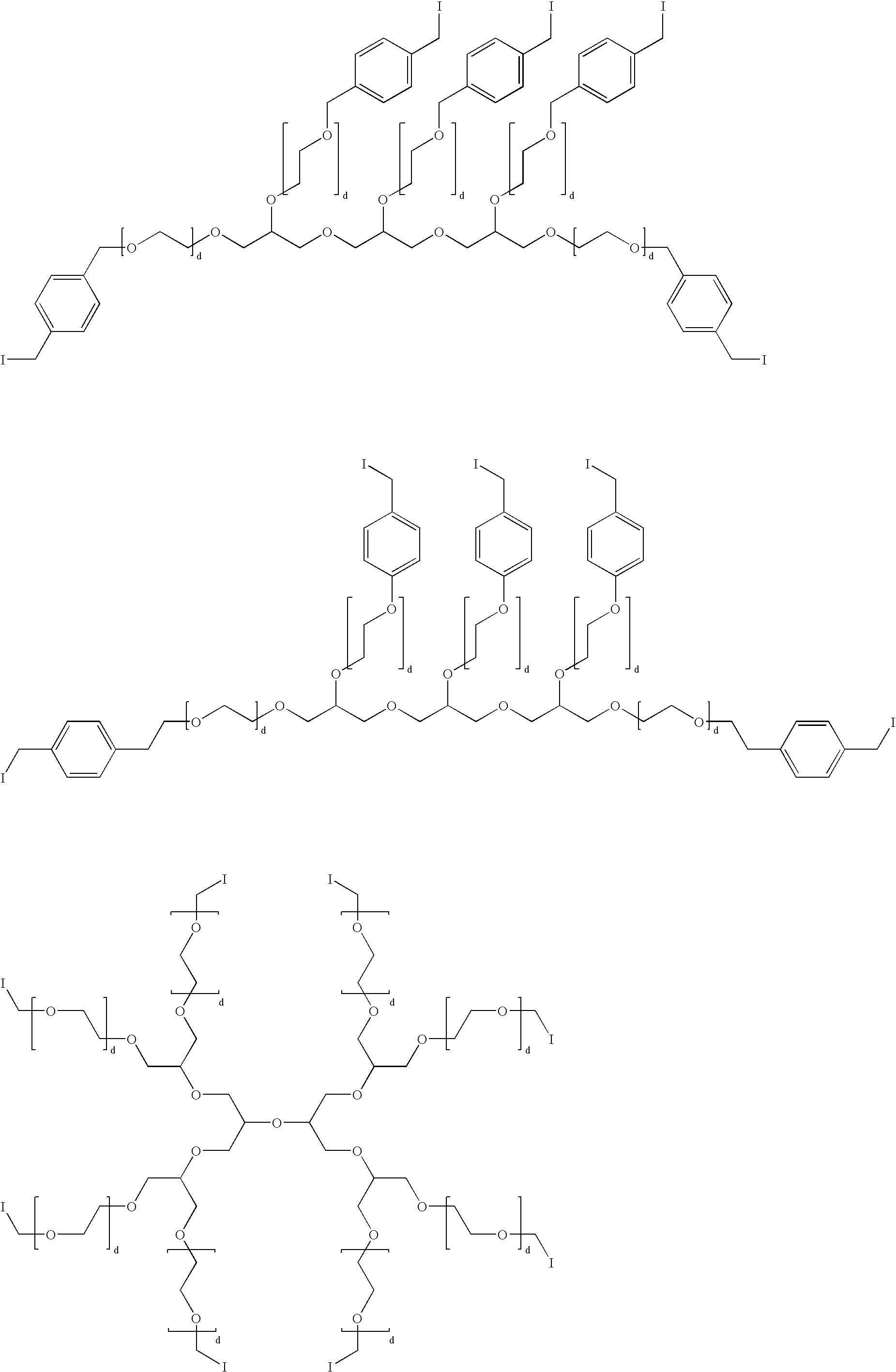

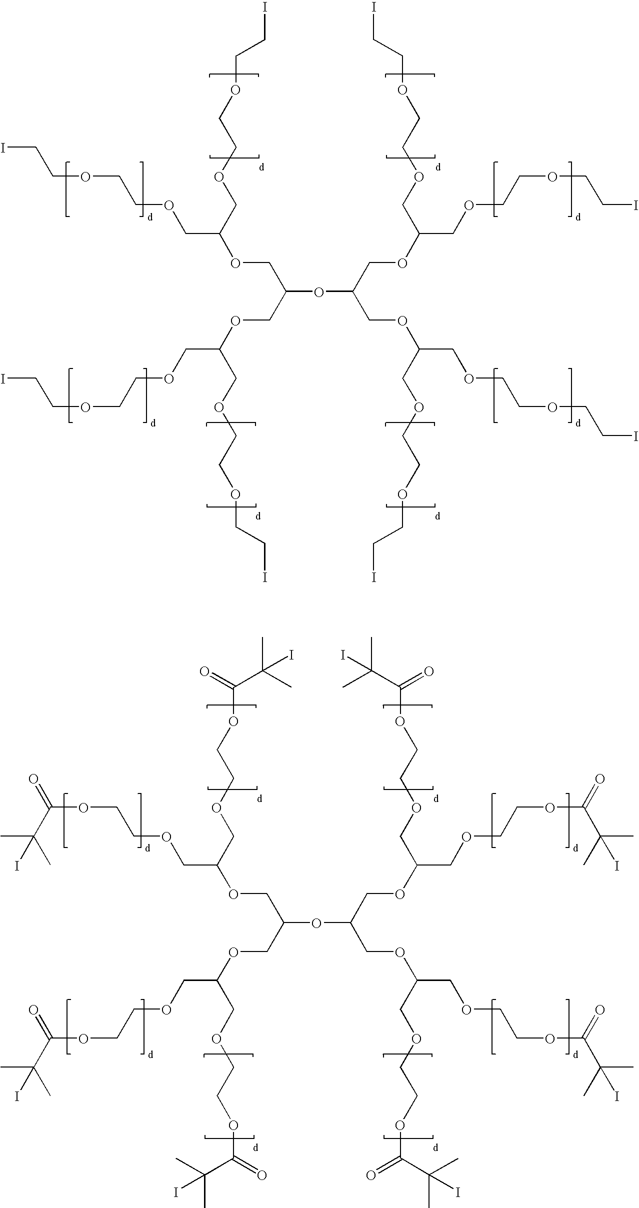

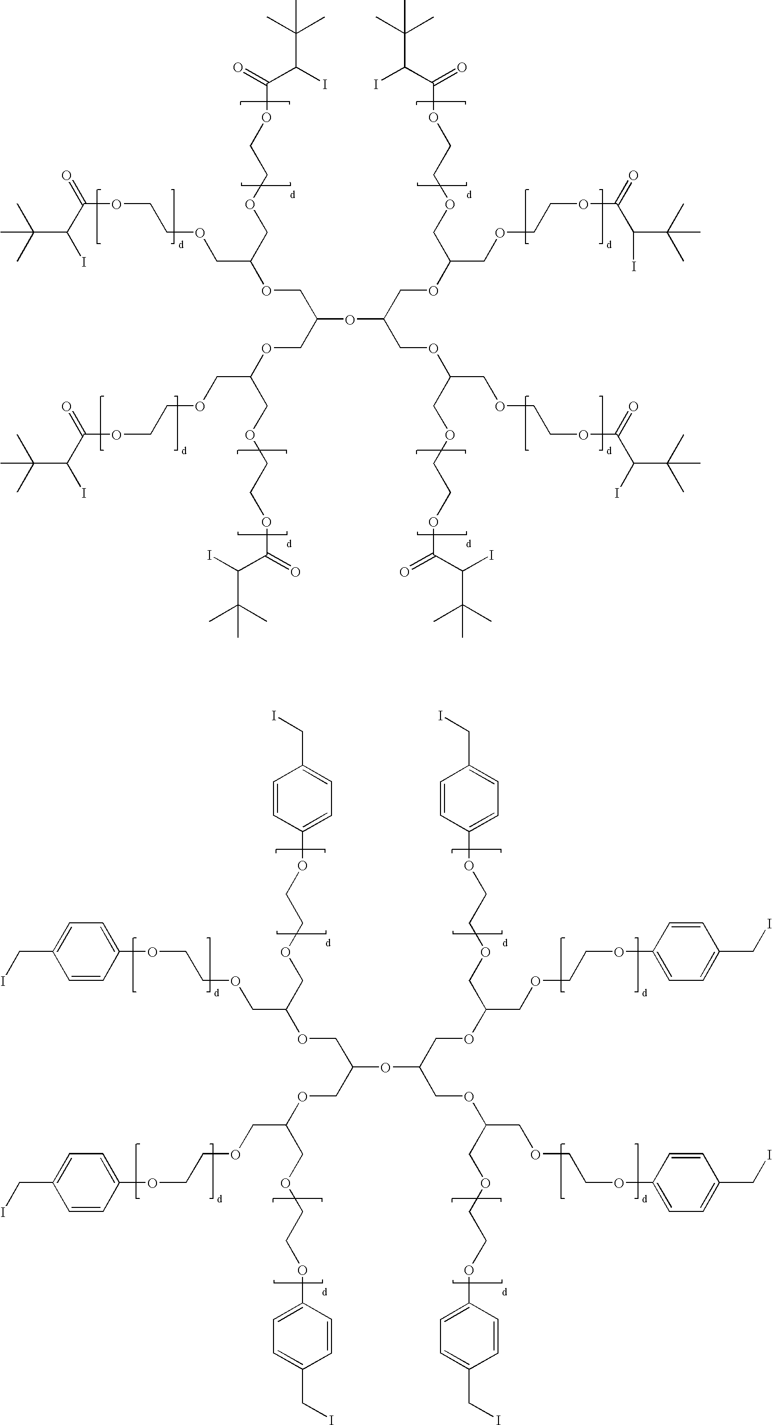

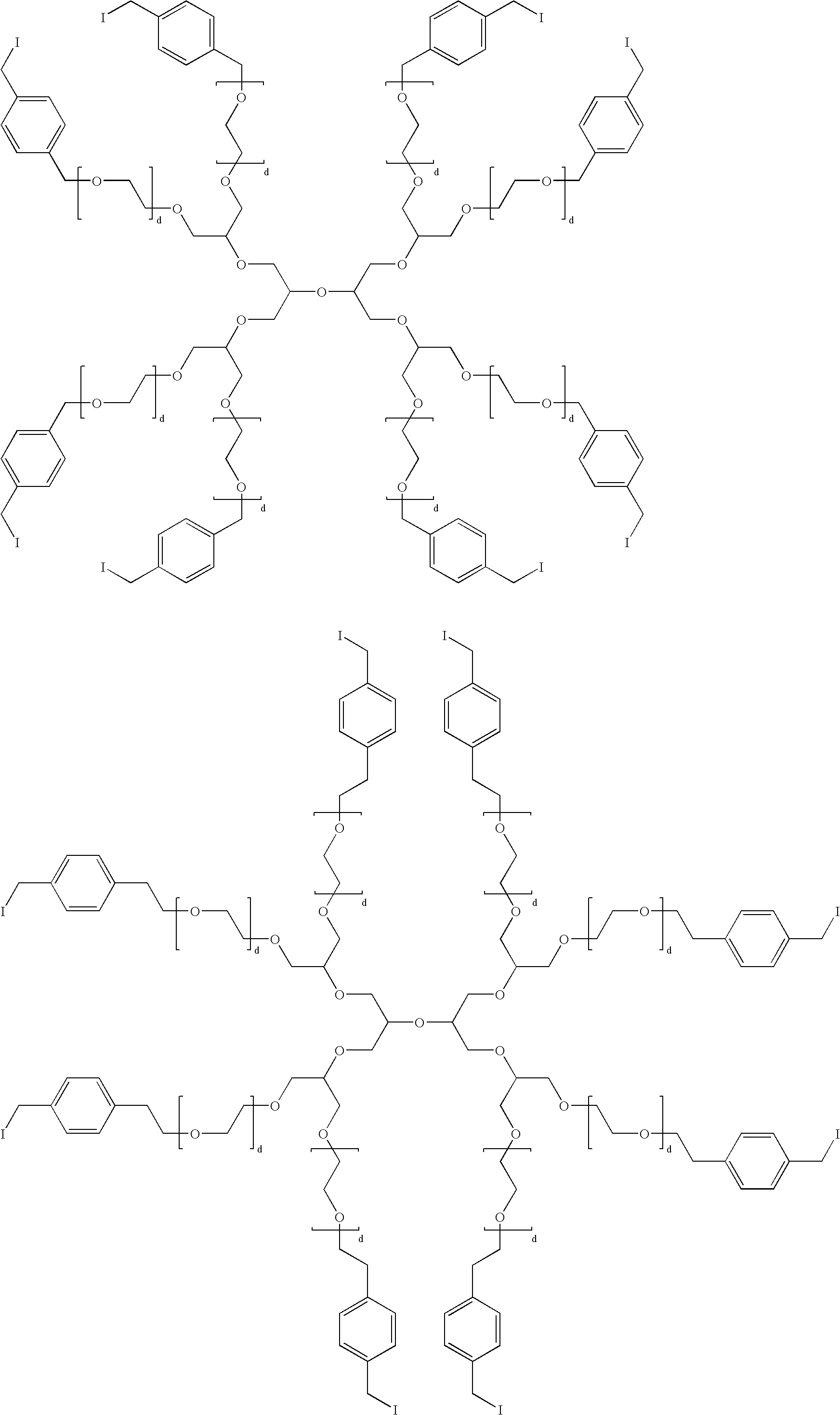

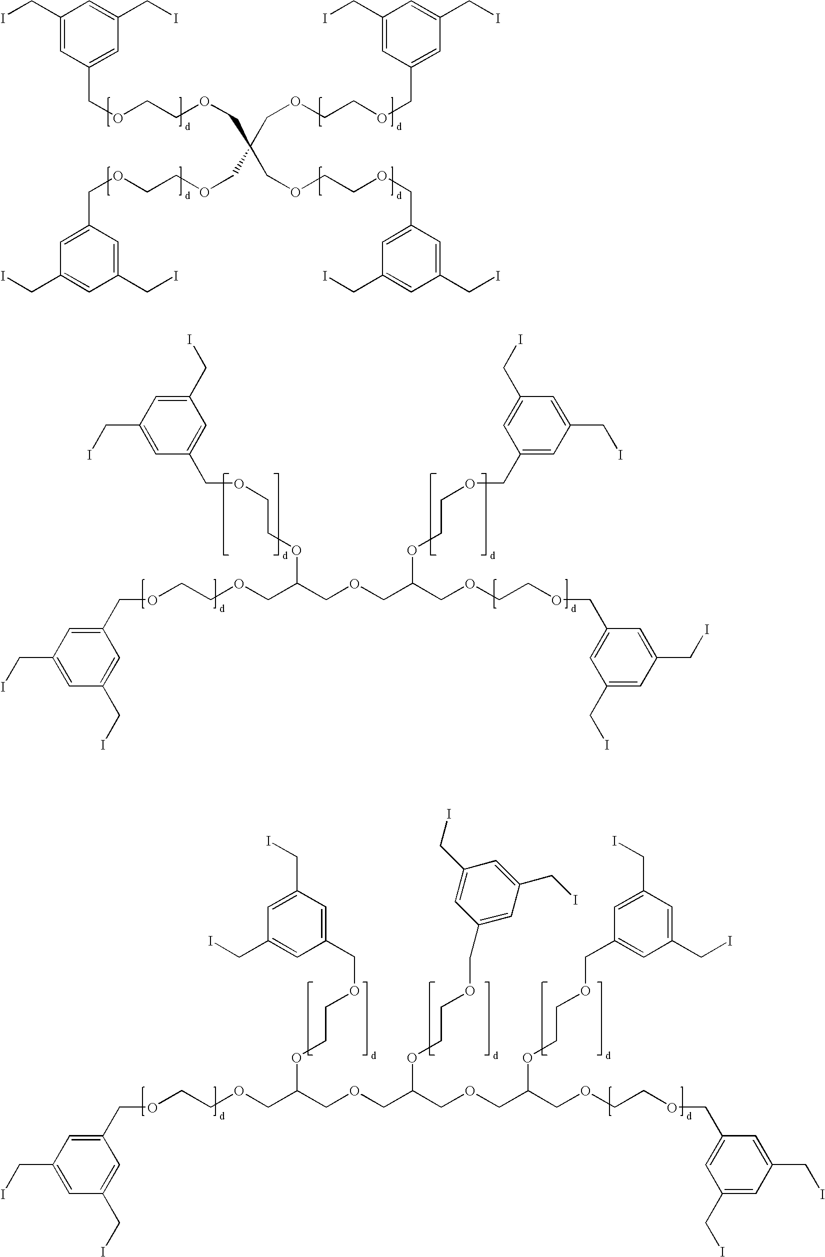

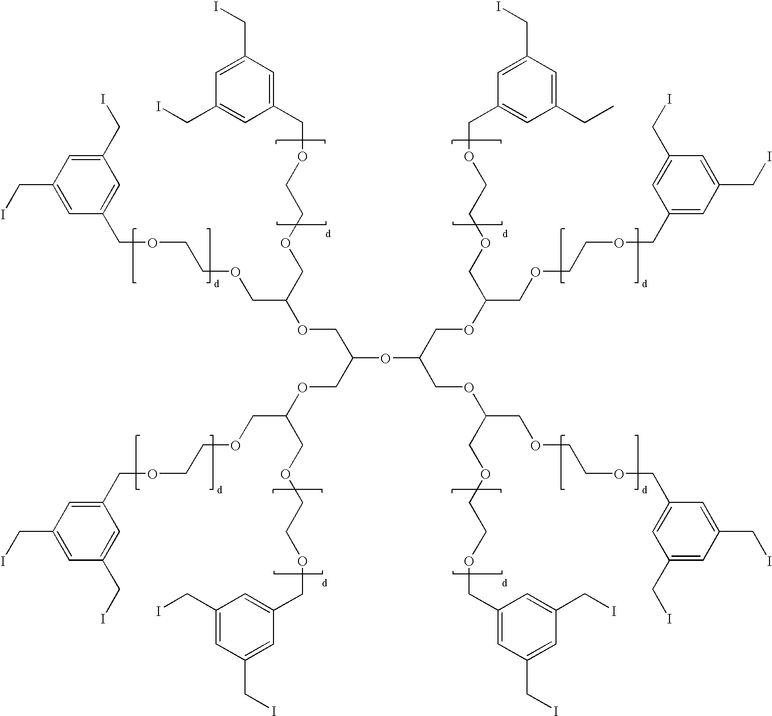

in which d is as defined above.

Illustrative examples, but not restricting the invention, of compounds of the formula II are as follows:

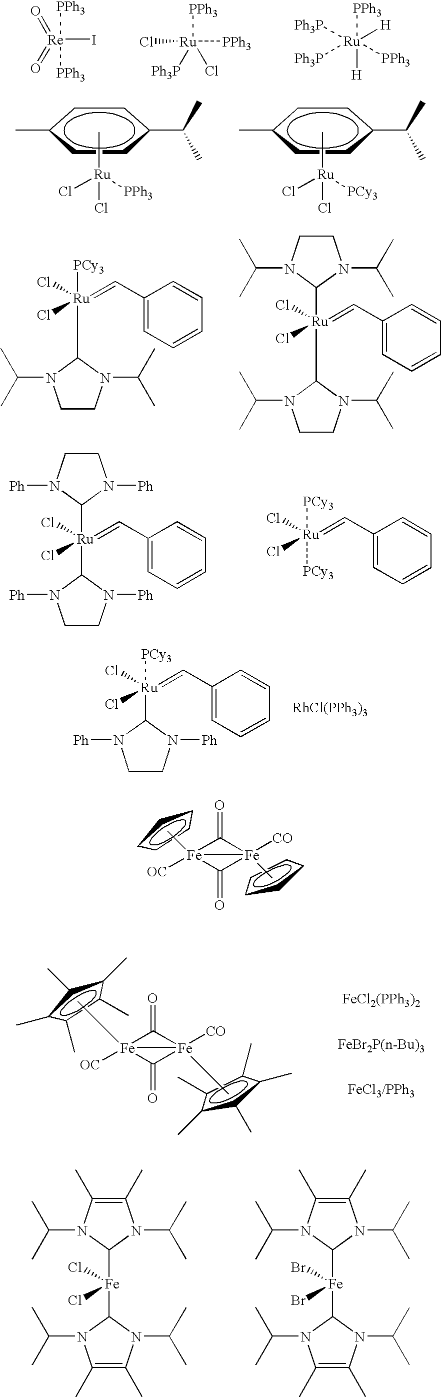

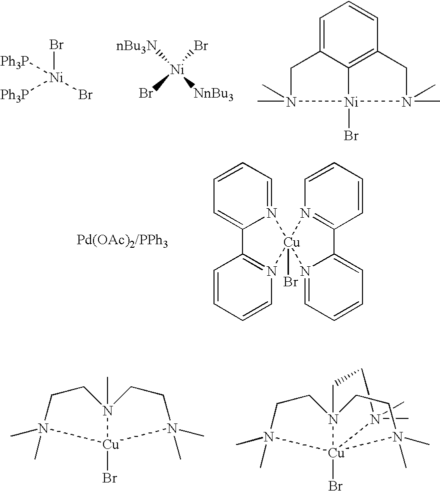

Illustrative examples, but not restricting the invention, of additives of the formula III are as follows:

Al(OMe)₃; Al(OEt)₃; Al(O-nPr)₃, Al(O-iPr)₃, Al(O-nBu)₃; Al(O-sBu)₃; Al(O-tBu)₃; MeAl(O-2,6-di-t-butylphenyl)₂; Al(OPh)₃; Ti(OMe)₄; Ti(OEt)₄; Ti(O-nPr)₄; Ti(O-iPr)₄; Ti(O-nBu)₄; Ti(O-sBu)₄; Ti(O-tBu)₄; LiOMe; LiOEt; LiO-nPr; LiO-iPr; LiO-nBu; LiO-sBu; LiO-tBu; B(OMe)₃; B(OEt)₃; B(O-nPr)₃; B(O-iPr)₃; B(O-nBu)₃; B(O-sBu)₃; B(O-tBu)₃; PPh₃; P-tBu₃; Et₃N; nBu₂NH.

The abbreviations in these formulae have the following definitions: Me=methyl, Et=ethyl, nPr=n-propyl, iPr=isopropyl, nBu=n-butyl, sBu=sec-butyl, tBu=tert-butyl and Ph=phenyl

The initiator systems of the invention are obtained by reacting a compound of the formula I, Ia or Ib with a metal compound of the formula II. Preference is given to a reaction which uses a metal compound of the formula II stoichiometrically in relation to the radical-initiating halide groups X¹ that are present. In the preparation of the initiator system it is possible where appropriate for an additive of the formula III to be present, or an additive of the formula III may be introduced subsequently where appropriate. The concentration of additive of the formula III can be between 0.001 and 100 mol %, based on monomer employed; more preferably the concentration of additive of the formula III is between 0.01 and 20 mol %, based on monomer employed. Preparation of the initiator system can take place in the presence of one or more solvents or in vinyl esters, preferably in vinyl acetate, or in another liquid monomer.

A further element of the present invention is a process for polymerizing vinyl esters using an initiator system of the invention, polymerization here referring not only to the homopolymerization of vinyl esters but also to the copolymerization of vinyl esters with other olefins, Examples of other olefins are 1-olefins having 2-20, preferably 2 to 10 carbon atoms, such as ethene, propene, 1-butene, 1-pentene, 1-hexene, 1-decene, 4-methyl-1-pentene or 1-octene, styrene, dienes such as 1,3-butadiene, 1,4-hexadiene, vinylnorbornene, norbornadiene, ethylnorbornadiene and cyclic olefins such as norbornene, cyclopentadiene, tetracyclododecene or methylnorbornene, and polar monomers such as methyl acrylate, methyl methacrylate, acrylic acid, ethyl acrylate, n-butyl acrylate and 2-ethylhexyl acrylate.

In the process of the invention preference is given to homopolymerization of vinyl acetate or copolymerization of vinyl acetate with one or more 1-olefins having 4 to 20 carbon atoms, such as styrene, norbornene, methyl acrylate, methyl methacrylate, acrylic acid, ethyl acrylate, n-butyl acryate or 2-ethylhexyl acrylate. Examples of such copolymers are vinyl acetate/methyl methacrylate copolymers or vinyl acetate/methyl methacrylate/styrene terpolymers.

Polymerization is carried out at a temperature of 0 to 300° C., preferably 50 to 200° C., more preferably 50-80° C. The pressure is 0.5 to 2 000 bar, preferably 1 to 64 bar. The polymerization can be carried out in solution, in bulk, in suspension or in emulsion, continuously or batchwise, in one or more stages. Examples of suitable polymerization solvents are ethers, such as diethyl ether, dibutyl ether, methyl tert-butyl ether, tetrahydrofuran, dioxane, anisol, diphenyl ether, ethylphenyl ether, aliphatic hydrocarbons such as pentane, hexane and the like or aromatic hydrocarbons such as benzene, toluene, xylenes and the like, and also ethyl acetate, acetone, N,N-dimethylformamide, ethylene carbonate, methanol, ethanol, propanol, isopropanol or water. It is also possible in accordance with the invention to use mixtures of different solvents in different proportions.

Very particular preference is given to initiator systems for preparing polyvinyl acetate block copolymers, composed of a compound of the formulae I, Ia or Ib, cyclopentadienyliron dicarbonyl dimer (formula II) and aluminium triisopropoxide (formula III).

The invention further provides a process for purifying the polymers prepared by the process of the invention, which comprises the following steps:
(A) reacting at least one compound of the formula I, Ia or Ib with at least one metal compound of the formula II, optionally in the presence of at least one additive of the formula III;
(B) concentrating the reaction mixture from step A) to remove residual monomer and solvents, and
(C) dissolving the reaction mixture from step B) in one or more organic solvents;
(D) optionally oxidizing the catalyst present in the mixture, by stirring in the presence of atmospheric oxygen or addition of oxidizing agents;
(E) optionally separating off reaction products formed during the oxidization in step D);
(F) precipitating the polymer by adding the polymer solution to one or more apolar aprotic solvents, separating the supernatant solvent, and optionally drying the polymer obtained;
(G) where appropriate, redissolving the polymer obtained from step F) in one or more organic solvents,
(H) precipitating the polymer by adding the solution from step G) to water or to an aqueous solution of an acid or to an aqueous solution of a base, where appropriate with stirring and cooling,
(I) isolating the precipitated polymer, preferably by filtration or phase separation, optionally washing the polymer with water or with one of the liquids specified in step H),
(J) optionally repeating steps G), H) and I), and
(K) drying the polymer.

The solvents employed in step C) are preferably (i) aromatic hydrocarbons, especially toluene, benzene or xylene, (ii) ketones, especially acetone, diethyl ketone or methyl isobutyl ketone, (iii) ethers especially diethyl ether, dibutyl ether, methyl tert-butyl ether, tetrahydrofuran, anisol or dioxane, (iv) esters, particularly those such as methyl acetate or ethyl acetate, (v) alcohols, especially methanol, ethanol or isopropanol, (vi) halogenated hydrocarbons, especially dichloromethane or trichldromethane, and (vii) ethylene carbonate or (viii) N,N-dimethylformamide.

The oxidizing agent used in step D) is, in particular, hydrocarbon peroxide, sodium peroxide, sodium hypochlorite, sodium perborate, sodium peroxodisulphate, potassium peroxodisulphate, potassium permanganate, potassium chlorate, calcium peroxide, tert-butyl hydroperoxide, or m-chloroperbenzoic acid, the oxidizing agent being able to be added either as a solid or in solution.

The solvents employed in step F) are, in particular, aliphatic hydrocarbons, more preferably n-pentane, n-hexane, isohexane or n-heptane.

The solvents employed in step G) are preferably (i) aromatic hydrocarbons, especially toluene, benzene or xylene, (ii) ketones, especially acetone, diethyl ketone or methyl isobutyl ketone, (iii) ethers especially diethyl ether, dibutyl ether, methyl tert-butyl ether, tetrahydrofuran, anisole or dioxane, (iv) esters, particularly those such as methyl acetate or ethyl acetate, (v) alcohols, especially methanol, ethanol or isopropanol, (vi) halogenated hydrocarbons, especially dichloromethane or trichloromethane, and (vii) ethylene carbonate or (viii) N,N-dimethylformamide.

The acids used in step H) are preferably organic and/or inorganic acids, particularly hydrogen fluoride, hydrochloric acid, hydrogen bromide, hydrogen iodide, phosphoric acid, phosphorous acid, hypophosphorous acid, sulphuric acid, sulphurous acid, is acetic acid, tartaric acid, nitric acid, nitrous acid, ammonium chloride or citric acid. The bases used in step H) are preferably organic and/or inorganic bases, particularly sodium hydroxide, potassium hydroxide, magnesium hydroxide, calcium hydroxide, ammonia, tetramethylethylenediamine, trimethylamine, triethylamine, sodium EDTA or hexamethylenetetramine.

The polymer purified by the process of the invention is colourless and contains no solvent and no residual monomer.

One preferred embodiment of the process of the invention comprises steps A) and B) as described above, dissolving the reaction mixture as per step C) in acetone, toluene and/or methanol, precipitating the polymer as per step F) by adding the solution from step C) to n-heptane and subsequently separating off the solvent, redissolving the polymer in acetone as per step G), adding the solution, preferably with stirring, to an inorganic acid as per step H), isolating the precipitated polymer and washing the polymer with water, and subsequently drying the polymer.

One particularly preferred embodiment of the process of the invention comprises steps A) and B) as described above, dissolving the reaction mixture as per step C) in acetone, precipitating the polymer as per step F) by adding the solution from step C) to n-heptane and subsequently separating off the solvent, redissolving the polymer in acetone as per step G), adding the solution, preferably with stirring, to a 1 molar hydrochloric acid as per step H), isolating the precipitated polymer and washing the polymer with water, and subsequently drying the polymer.

The invention further provides for the reaction of the polyvinyl ester-polyalkylene glycol block copolymers, prepared as above, to give polyvinyl alcohol-polyalkylene glycol block copolymers, comprising the following steps:
L) Dissolving the polymer from step K) in one or more organic solvents,
M) Adding the solution from L) dropwise to a solution of an acid or a solution of a base in one or more aqueous or one or more organic solvents, where appropriate with heating and stirring,
N) Reacting the mixture from M) for a defined period, where appropriate with heating and stirring,
O) Isolating the polymer by filtering the mixture from N),
P) Washing the polymer with an organic solvent, and
Q) Drying the polymer.

The solvents employed in steps L) and P) are preferably (i) aromatic hydrocarbons, especially toluene, benzene or xylene, (ii) ketones, especially acetone, diethyl ketone or methyl isobutyl ketone, (iii) ethers especially diethyl ether, dibutyl ether, methyl tert-butyl ether, tetrahydrofuran, anisole or dioxane, (iv) esters, particularly those such as methyl acetate or ethyl acetate, (v) alcohols, especially methanol, ethanol or isopropanol, (vi) halogenated hydrocarbons, especially dichloromethane or trichloromethane, and (vii) ethylene carbonate or (viii) N,N-dimethylformamide.

The acids used in step M) are preferably organic and/or inorganic acids, particularly hydrogen fluoride, hydrochloric acid, hydrogen bromide, hydrogen iodide, phosphoric acid, phosphorous acid, hypophosphorous acid, sulphuric acid, sulphurous acid, acetic acid, tartaric acid, nitric acid, nitrous acid, ammonium chloride or citric acid. The bases used in step M) are preferably organic and/or inorganic bases, particularly sodium hydroxide, potassium hydroxide, magnesium hydroxide, calcium hydroxide, ammonia, tetramethylethylenediamine, trimethylamine, triethylamine, sodium EDTA or hexamethylenetetramine. The solvents employed in step M) are preferably (i) aromatic hydrocarbons, especially toluene, benzene or xylene, (ii) ketones, especially acetone, diethyl ketone or methyl isobutyl ketone, (iii) ethers especially diethyl ether, dibutyl ether, methyl tert-butyl ether, tetrahydrofuran, anisole or dioxane, (iv) esters, particularly those such as methyl acetate or ethyl acetate, (v) alcohols, especially methanol, ethanol or isopropanol, (vi) halogenated hydrocarbons, especially dichloromethane or trichloromethane, and (vii) ethylene carbonate or (viii) N,N-dimethylformamide, and also water.

The degree of hydrolysis of the polymer can be set by way of the reaction period in step N): a shorter reaction period leads to a lower degree of hydrolysis, while a longer reaction period leads to complete hydrolysis.

One preferred embodiment of the process of the invention comprises dissolving the polymer as per step L) in methanol and/or acetone, adding the solution dropwise to a methanolic or aqueous solution of an inorganic base as per step M), reacting the mixture from M) at elevated temperature as per step N) for a defined period, filtering the suspension as per step O) and washing the polymer with methanol and/or acetone as per step P), and drying the polymer as per step Q).

One particularly preferred embodiment of the process of the invention comprises dissolving the polymer as per step L) in methanol, adding the solution dropwise to a methanolic solution of sodium hydroxide (1% NaOH in methanol) as per step M), reacting the mixture from M) at 50° C. as per step N) for one hour, filtering the suspension as per step O) and washing the polymer with methanol as per step P), and drying the polymer as per step Q).

The invention further provides for the reaction of the polyvinyl alcohol-polyalkylene glycol block copolymers prepared as above to give polyvinyl acetal-polyalkylene glycol block copolymers, which comprises the following steps:
R) dissolving the polymer from step Q) in water or an aqueous solution of an acid,
S) adding the solution from R) dropwise to a ketone or an aldehyde, where appropriate with stirring and heating,
T) reacting the mixture from S) for a defined period, where appropriate with heating and stirring,
U) if desired, adding an acid and reacting the mixture for a defined period, where appropriate with heating and stirring,
V) isolating the polymer by filtering the mixture from T) or from U) and washing the polymer with water,
W) if desired, purifying the polymer by dissolving it in an organic solvent and precipitating it by adding the solution to water, and isolating the polymer, by filtration for example,
X) drying the polymer.

The acids used in steps R) and U) are preferably organic and/or inorganic acids, particularly hydrogen fluoride, hydrochloric acid, hydrogen bromide, hydrogen iodide, phosphoric acid, phosphorous acid, hypophosphorous acid, sulphuric acid, sulphurous acid, acetic acid, tartaric acid, nitric acid, nitrious acid, ammonium chloride or citric acid.

The aldehydes and ketones used in step S) are preferably formaldehyde, acetaldehyde, propionaldehyde, butyraldehyde, pentanal, hexanal, heptanal, octanal, nonanal, decanal, acetone, diethyl ketone, methyl ethyl ketone or methyl isobutyl ketone.

The solvents employed in step W) are preferably (i) aromatic hydrocarbons, especially toluene, benzene or xylene, (ii) ketones, especially acetone, diethyl ketone or methyl isobutyl ketone, (iii) ethers especially diethyl ether, dibutyl ether, methyl tert-butyl ether, tetrahydrofuran, anisol or dioxane, (iv) esters, particularly those such as methyl acetate or ethyl acetate, (v) alcohols, especially methanol, ethanol or isopropanol, (vi) halogenated hydrocarbons, especially dichloromethane or trichloromethane, and (vii) ethylene carbonate or (viii) N,N-dimethylformamide.

One preferred embodiment of the process of the invention comprises dissolving the polymer as per step R) in water or an aqueous solution of an acid, adding the solution from R) dropwise to a ketone or an aldehyde as per step S), reacting the mixture from S) at elevated temperature as per step T) for a defined period, optionally adding an acid, filtering the suspension from T) or from U) and washing the polymer with water as per step V), optionally purifying the polymer by dissolving it in an organic solvent and precipitating it by adding the solution to an aqueous solvent as per step w), and drying the polymer as per step X).

One particularly preferred embodiment of the process of the invention comprises dissolving the polymer as per step R) in 0.5%-1% strength aqueous sulphuric acid, adding the solution from R) dropwise to butyraldehyde as per step S), reacting the mixture from S) at 50-55° C. as per step T) for two minutes, adding 2% concentrated sulphuric acid and stirring the mixture at 50-55° C. for one hour as per step U), filtering the suspension from U) and washing the polymer with water as per step V), purifying the polymer by dissolving it in methanol and precipitating it by adding the solution to water as per step w), and drying the polymer as per step X).

The present invention additionally provides the block copolymers of the formulae IV, IVa and IVb, which are prepared by the reactions specified above:

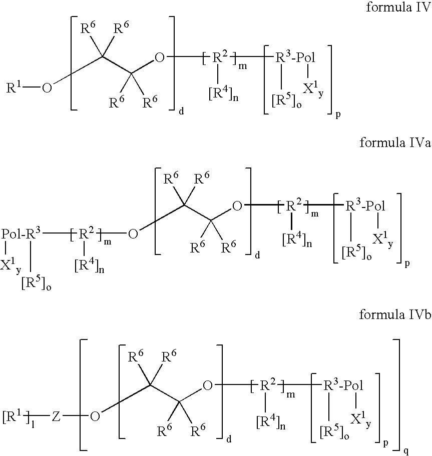

in which
Z is as defined above, and
R¹, R², R³, R⁴, R⁵, R⁶ are as defined above, and
d, l, m, n, o, p, q are as defined above, and
X¹ is as defined above, and
y can be identical or different, and is zero or one, and
Pol is a homopolymer or copolymer based on a polyvinyl ester, more preferably polyvinyl acetate, a homopolymer or copolymer based on a polyvinyl alcohol or a homopolymer or copolymer based on a polyvinyl acetal, more preferably polyvinyl butyral.

Illustrative examples, but not restricting the invention, of the polymers of the formula IV according to the invention are:

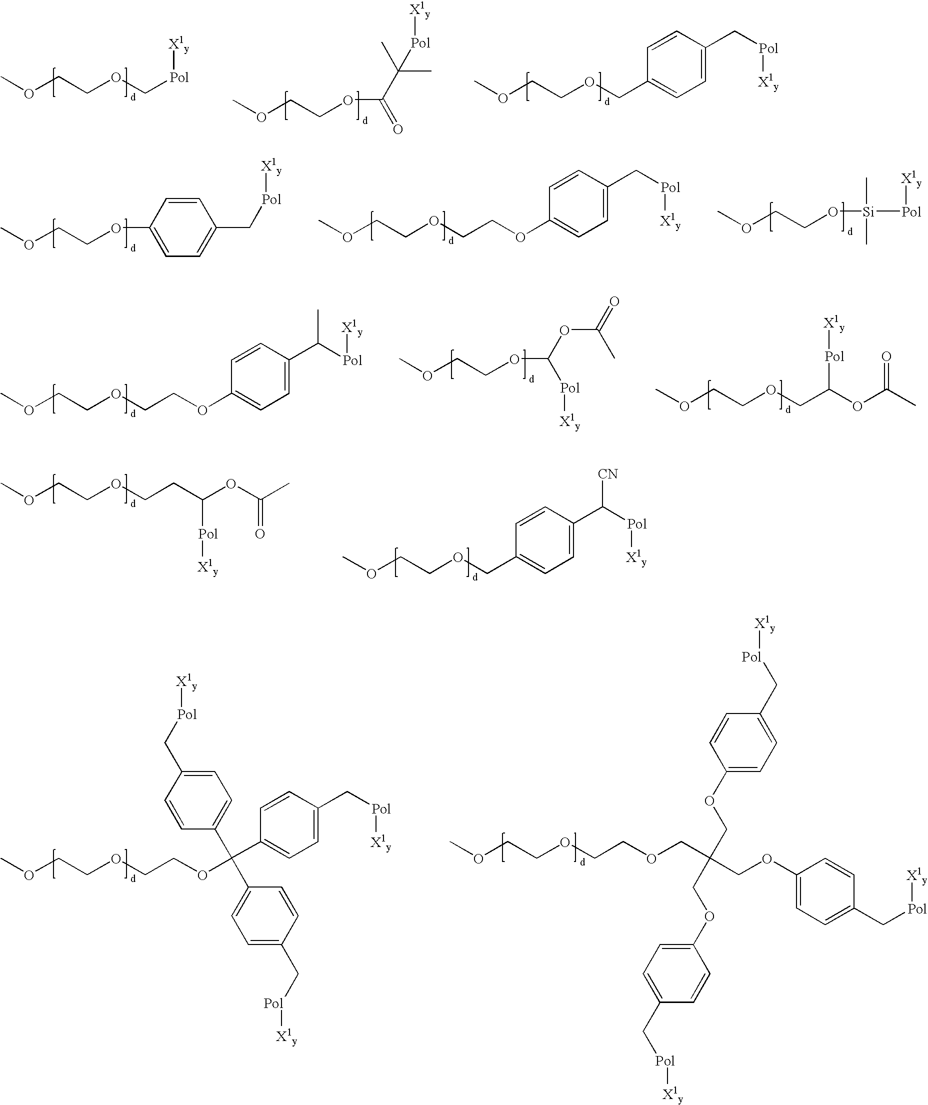

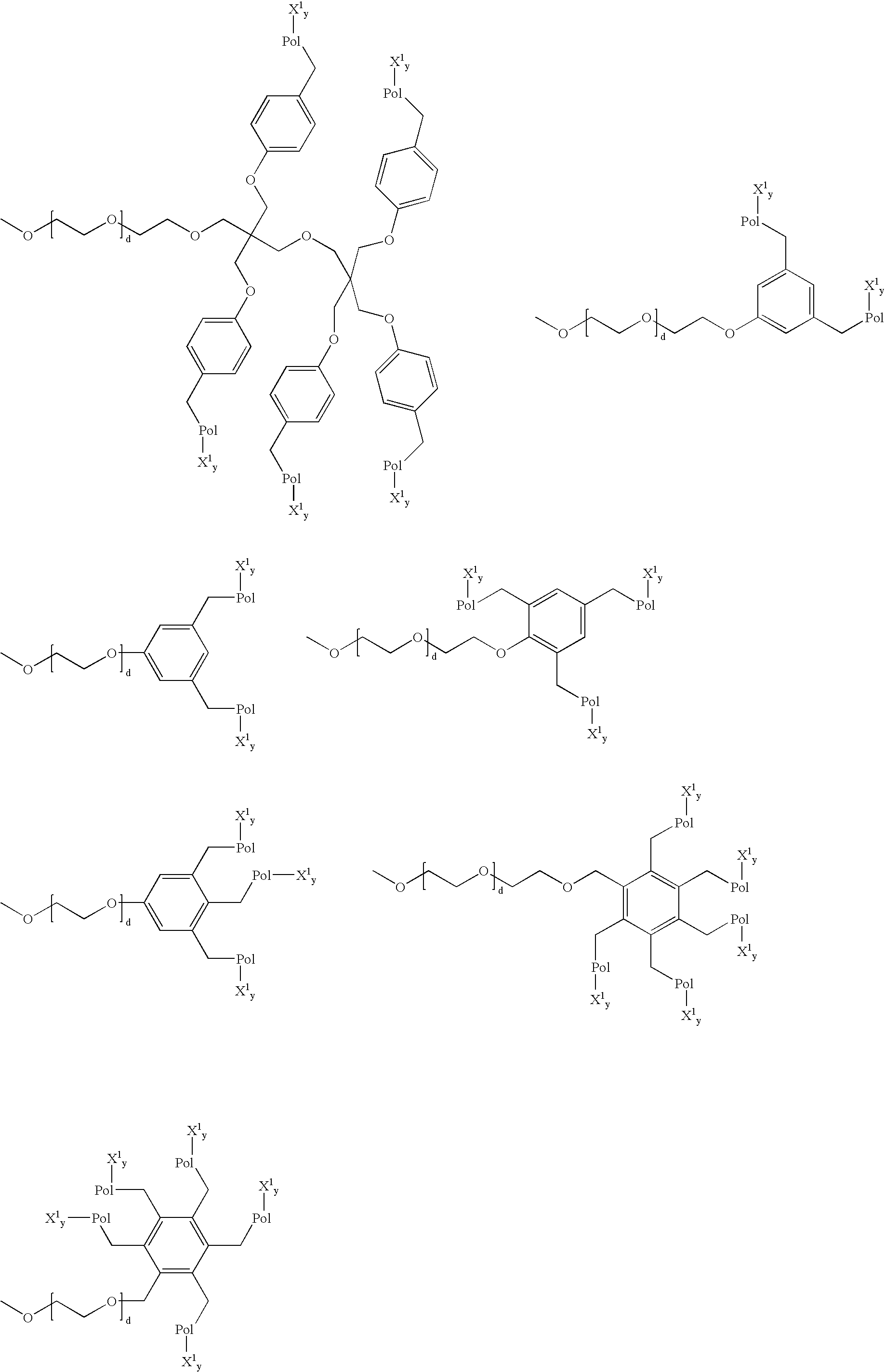

in which Pol, X¹, d and y are as defined above.

Illustrative examples, but not restricting the invention, of the polymers of the formula IVa according to the invention are:

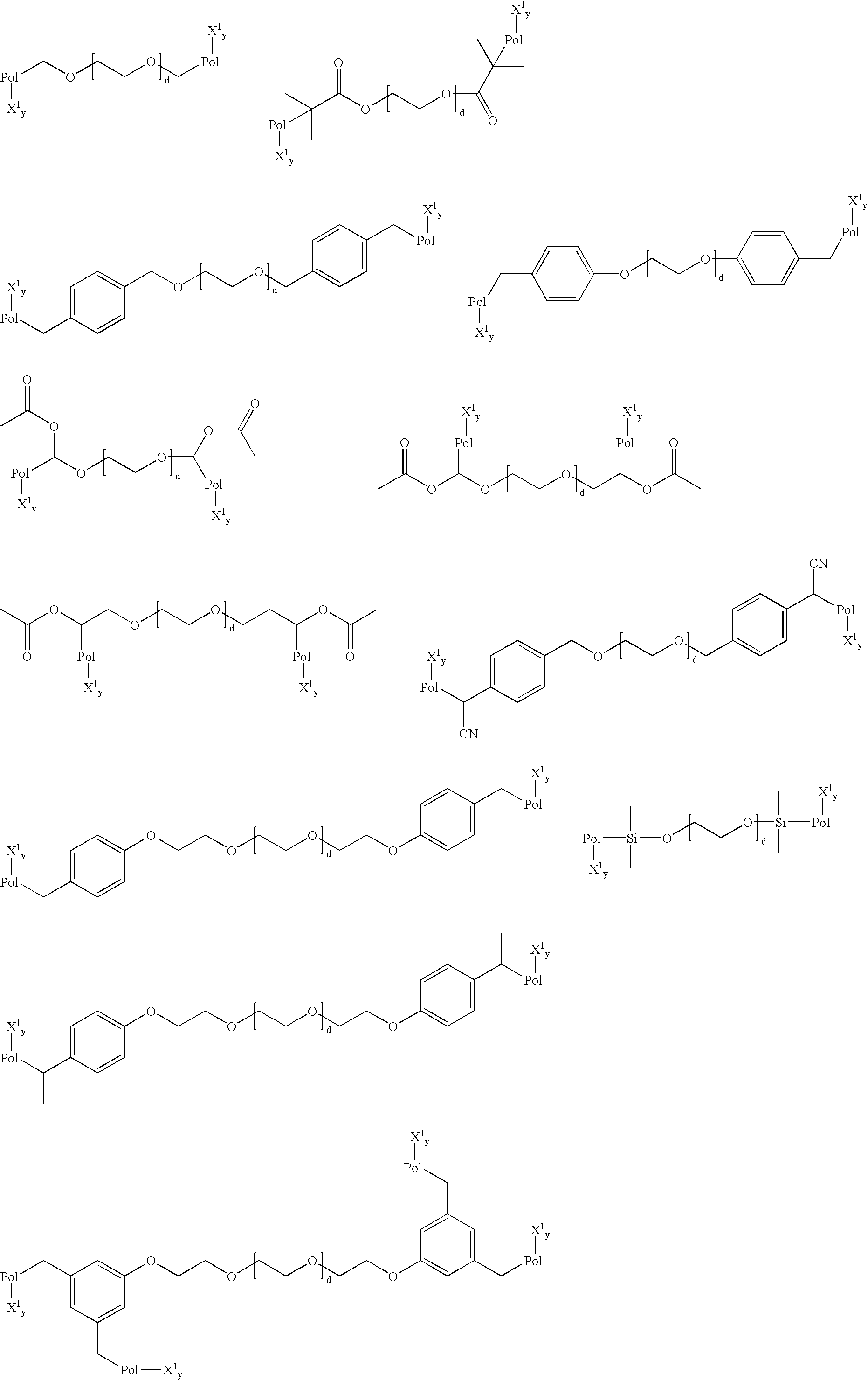

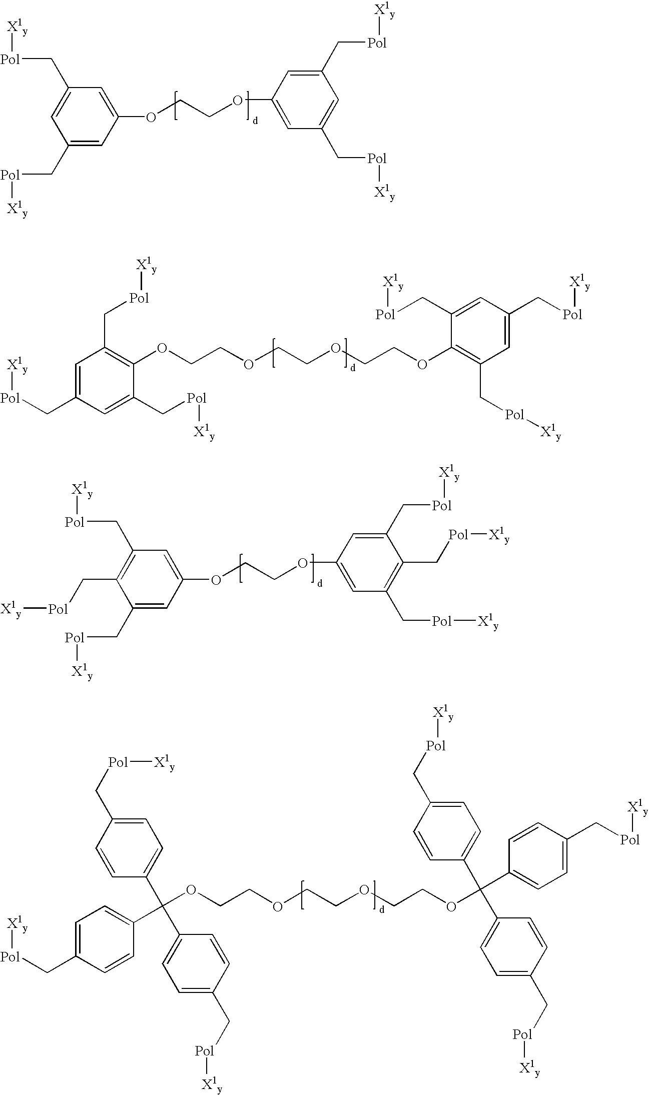

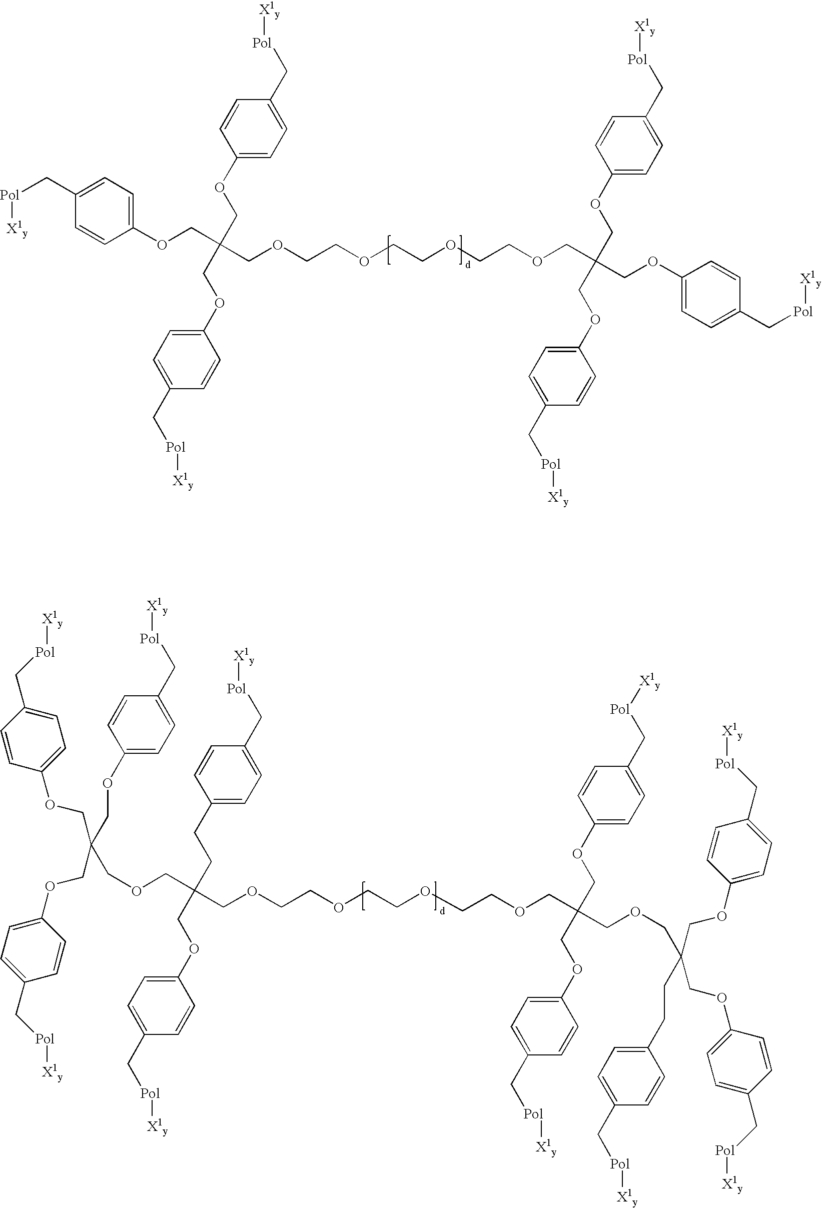

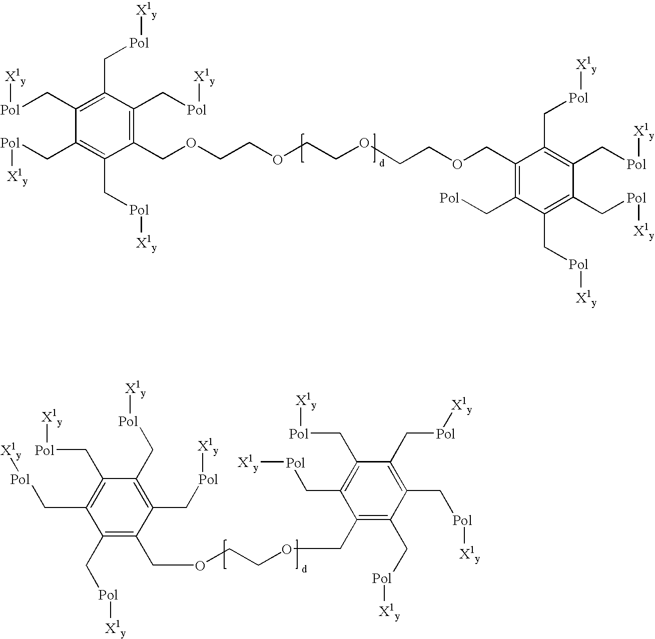

in which Pol, X¹, d and y are as defined above.

Illustrative examples, but not restricting the invention, of the polymers of the formula IVb according to the invention are:

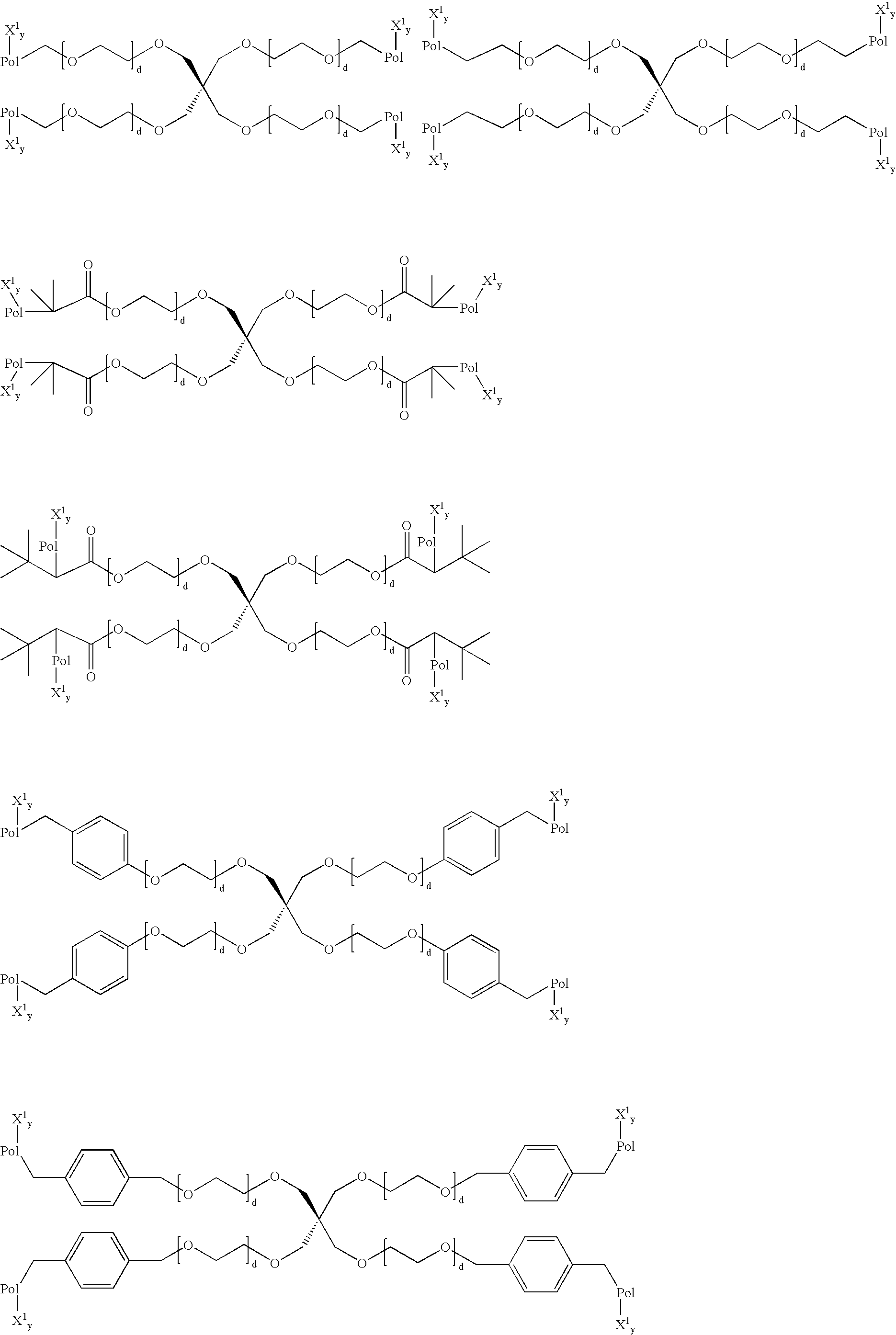

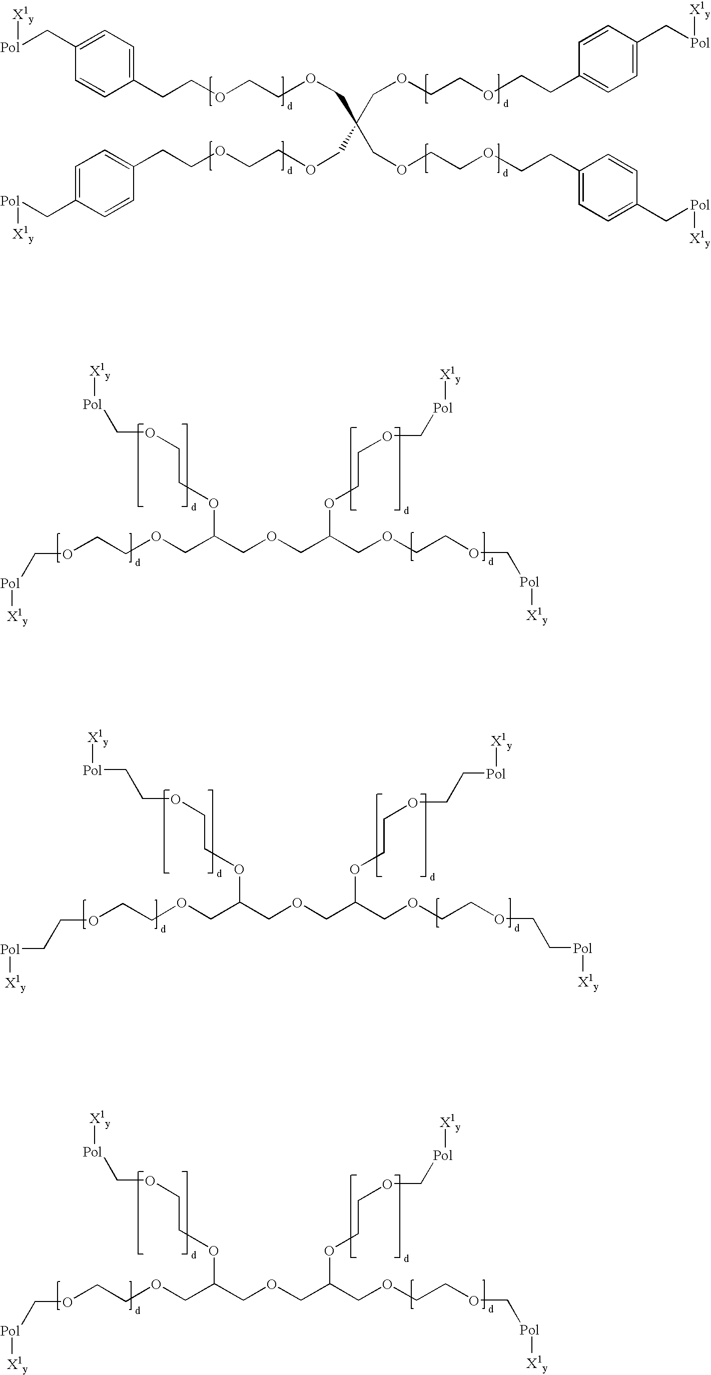

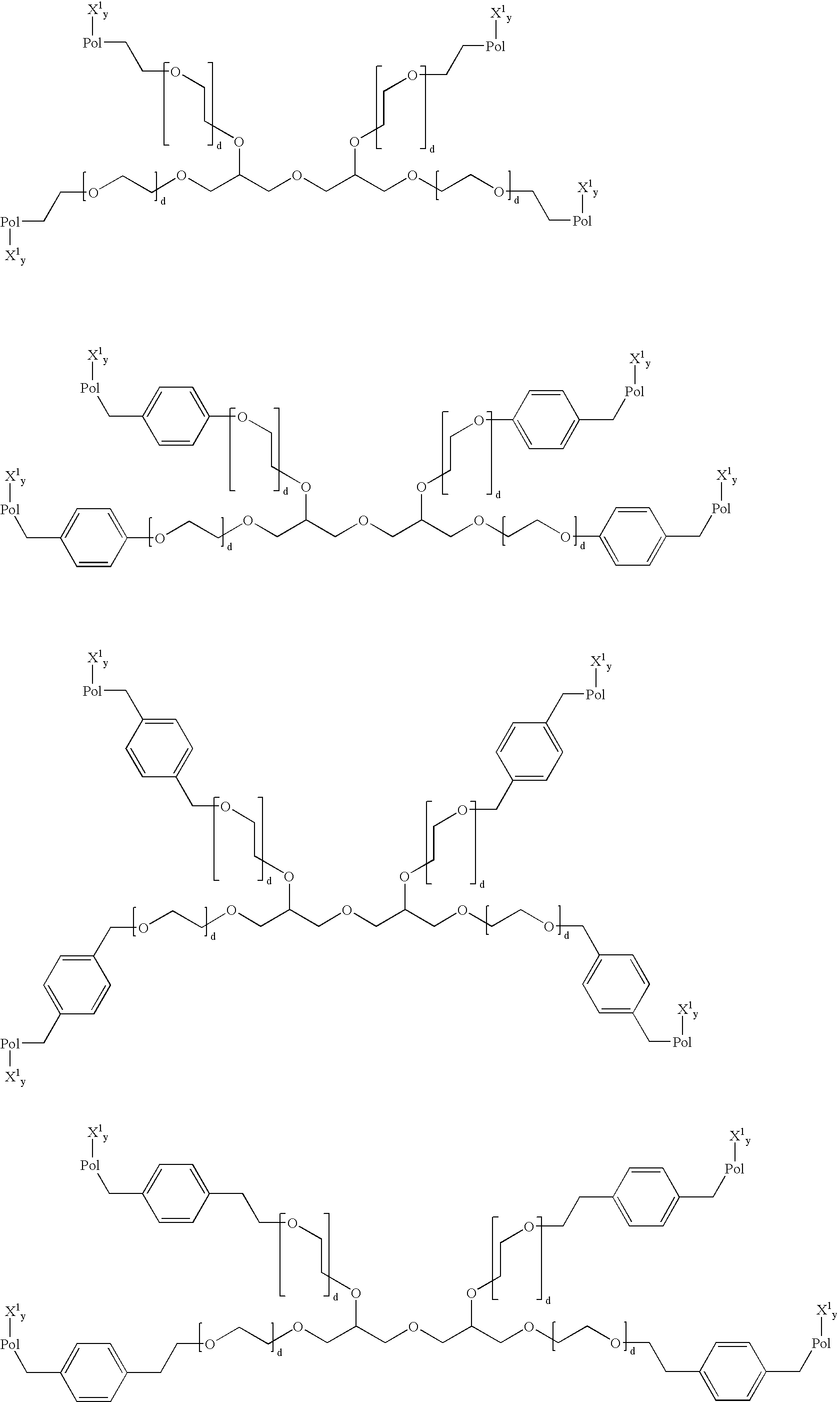

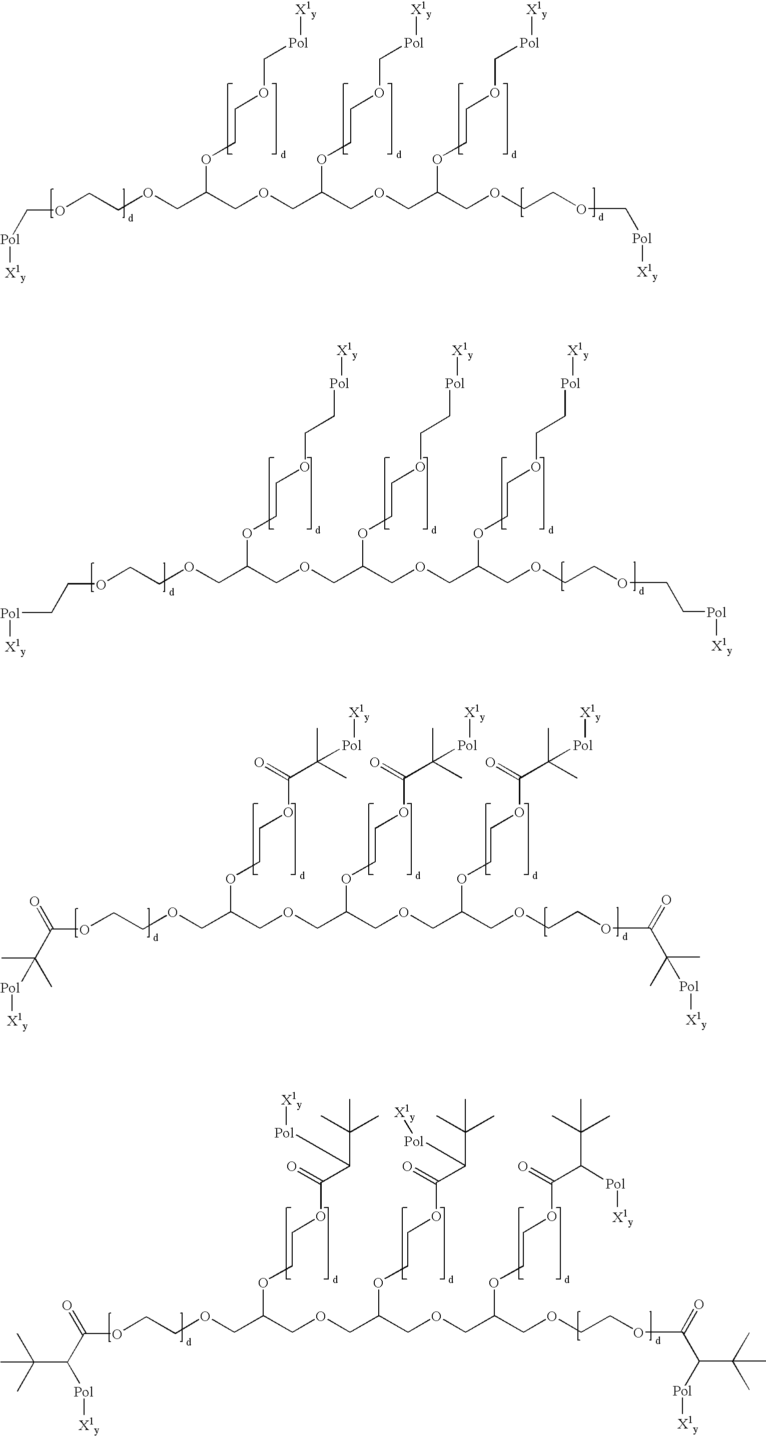

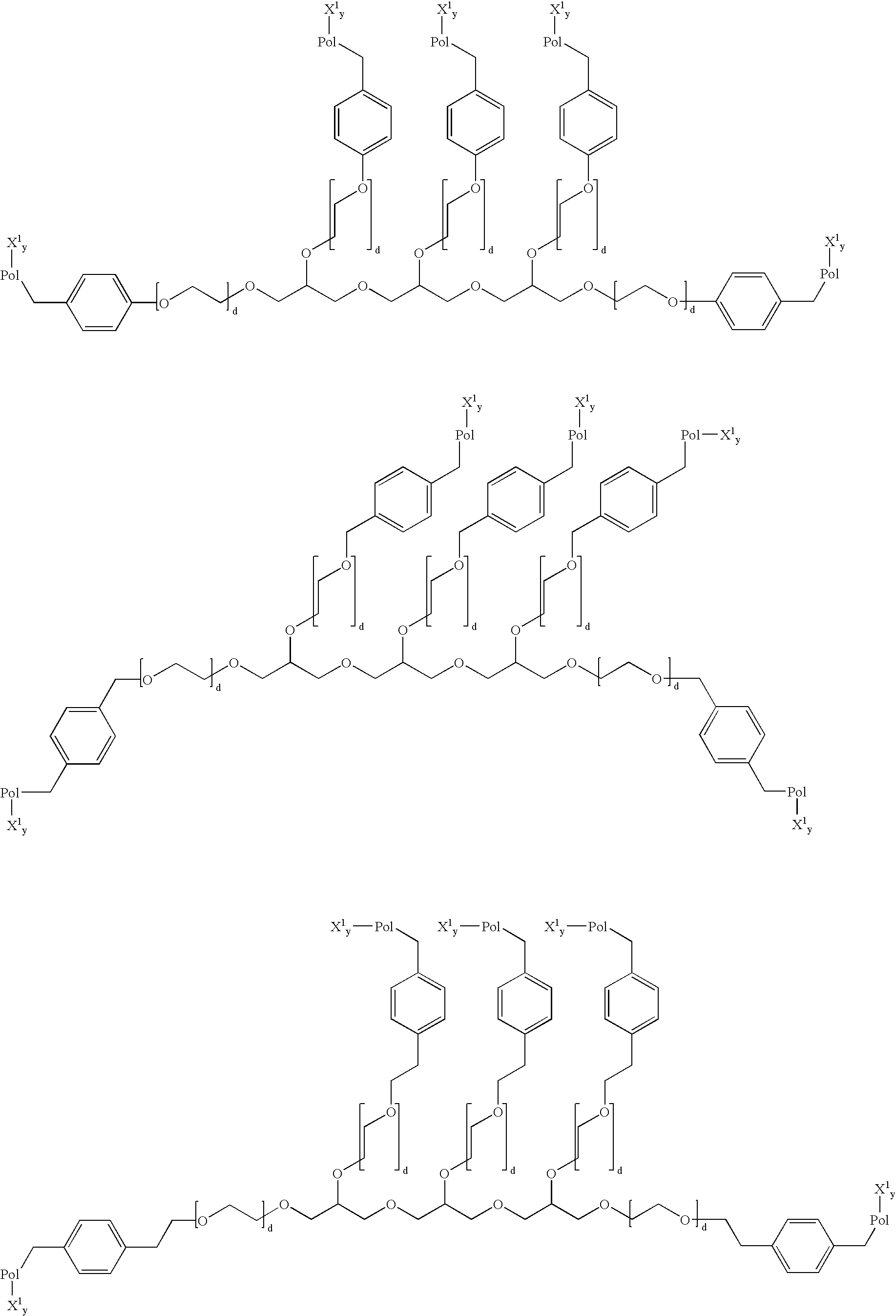

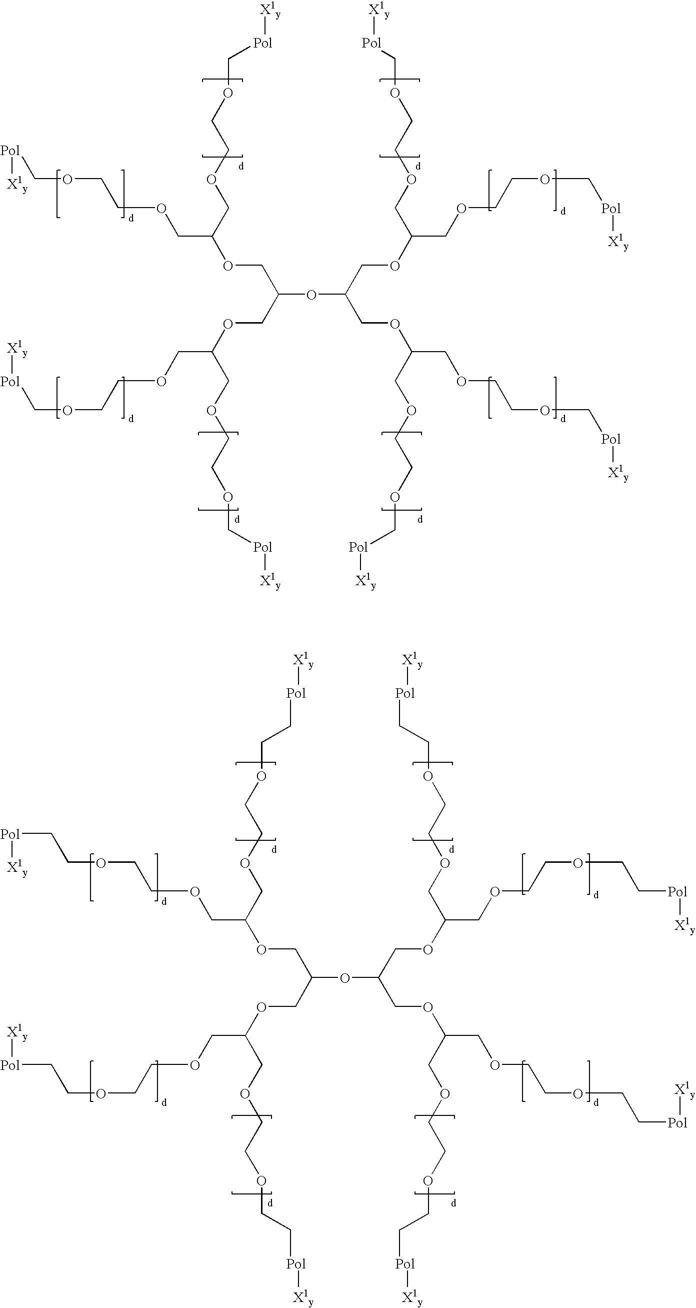

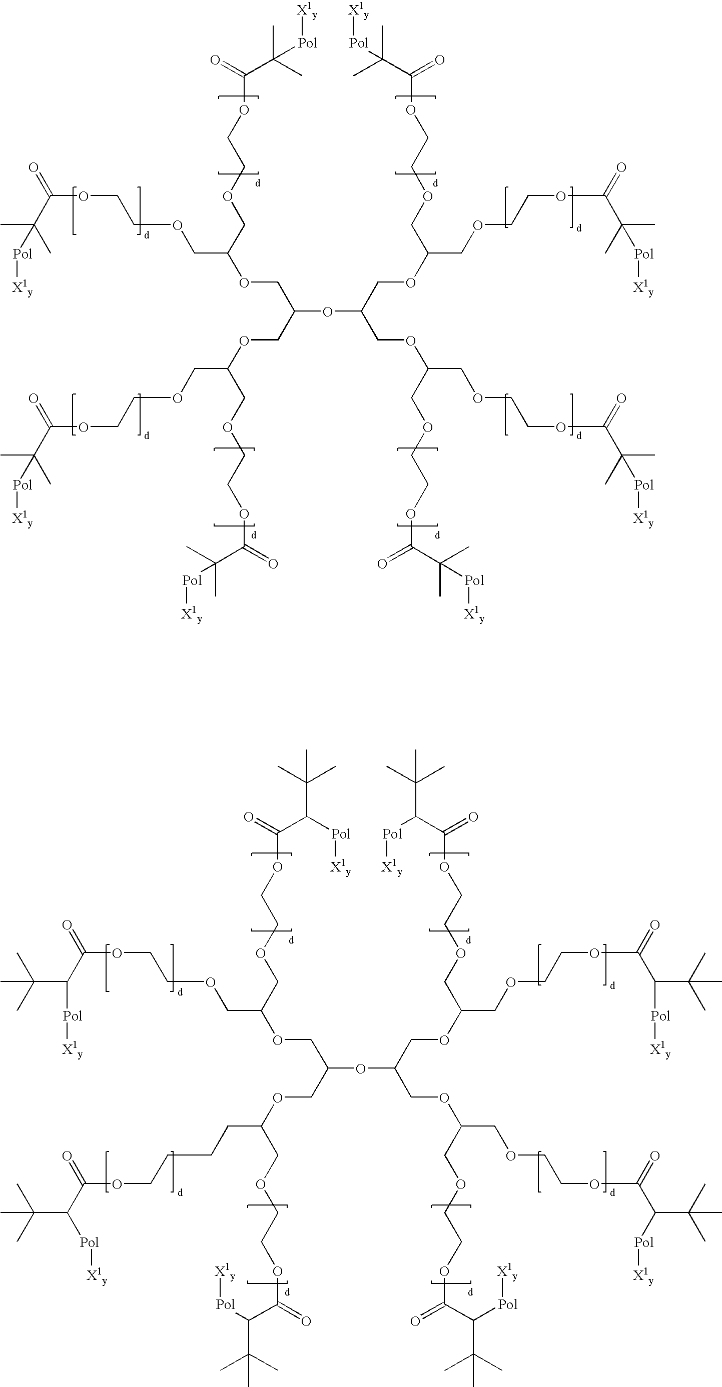

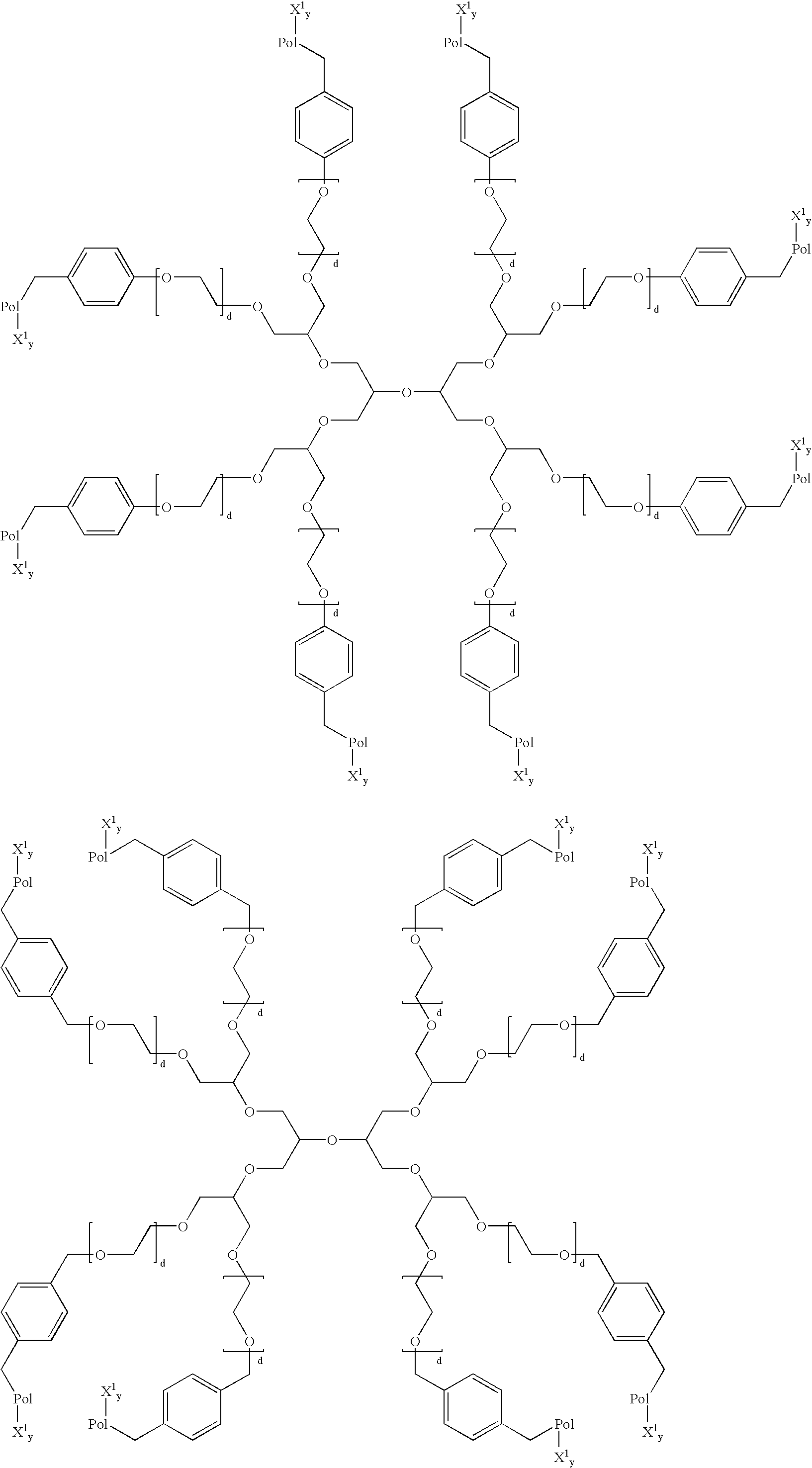

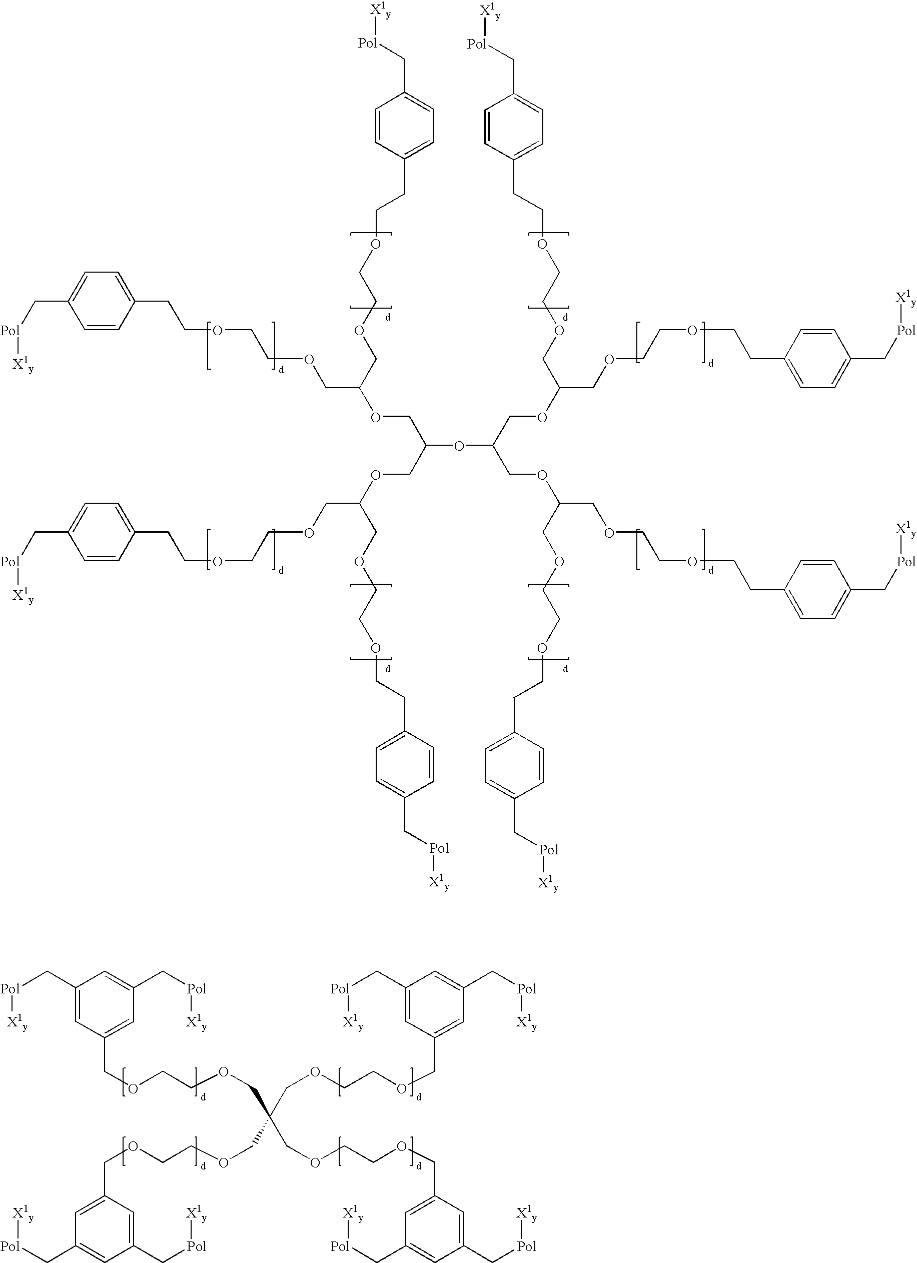

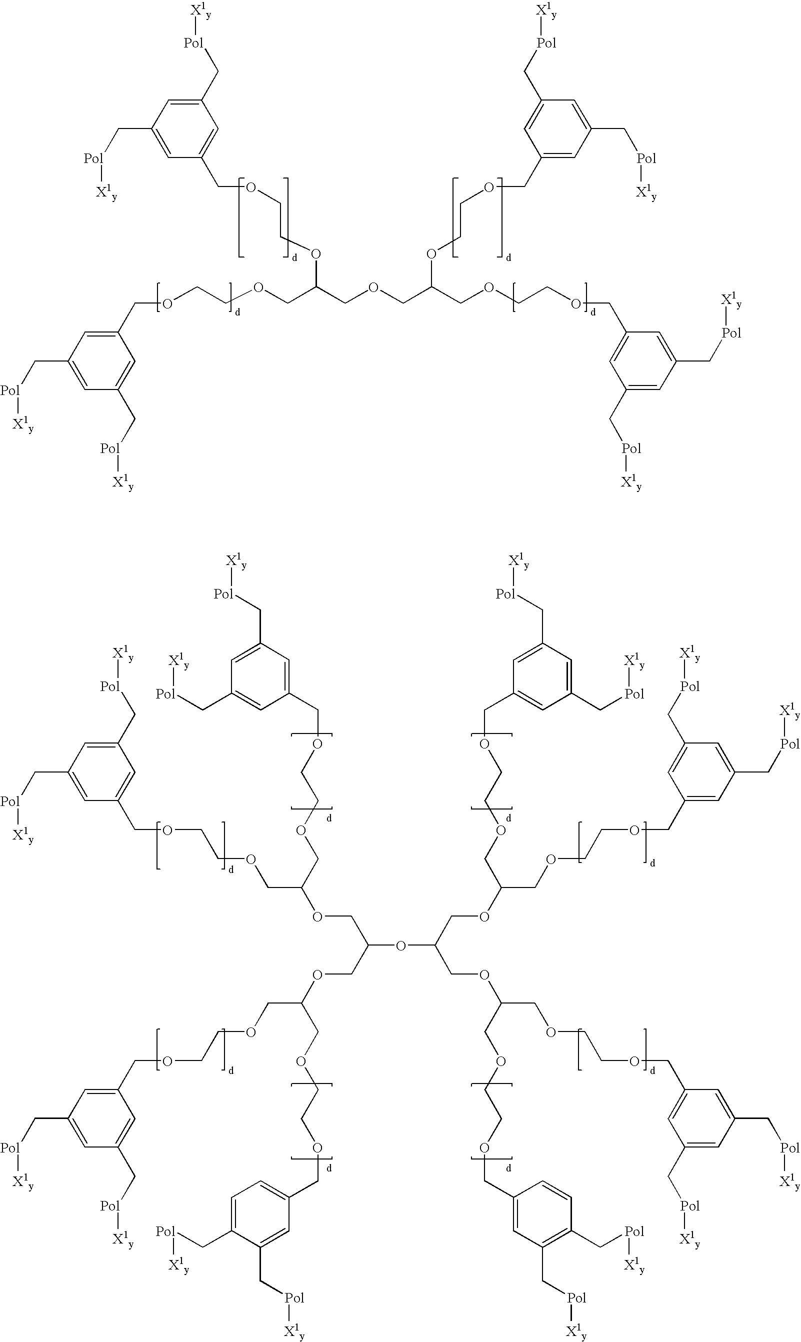

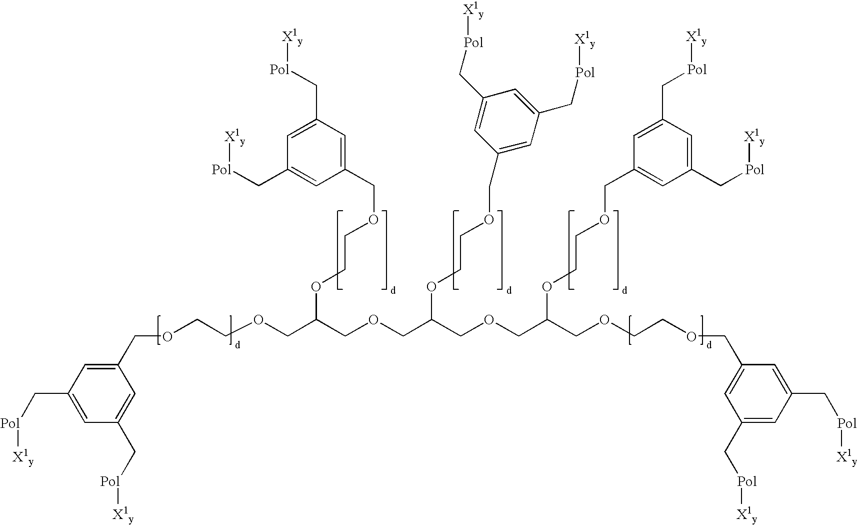

in which Pol, X¹, d and y are as defined above.

Additionally it is possible from these polyvinyl ester block copolymers to prepare polyvinyl alcohol block copolymers possessing outstanding suitability for use as water-soluble films, biodegradable and water-soluble polymers, detergents, an adhesive component, and an emulsifier

The polyvinyl ester-polyalkylene glycol block copolymers of formula IV, IVa and IVb are especially suitable for use as additives for motor fuels and engine oils, as additives to concrete, as additives in papermaking, as an adhesive (component), as a lubricant, as a coating component and as high-performance plastics.

The polyvinyl alcohol-polyalkylene glycol block copolymers of formula IV, IVa and IVb are especially suitable for use as water-soluble films, biodegradable and water-soluble polymers, detergents, an adhesive component and an emulsifier.

The polyvinyl acetal-polyalkylene glycol block copolymers of formula IV, IVa and IVb are especially suitable for use as a component for primers and coating materials, particularly for corrosion control of metals in wash primers (adhesion primers), for electrically insulating magnetic wires, for producing laminated glass sheets, as base materials for coatings, as adhesion primers, for textile coatings, for adhesives and for removable coatings.

The invention is illustrated by the following examples which do not, however, restrict the invention.

General Notes: The organometallic compounds were prepared and handled in the absence of air and moisture, under argon inert gas (Schlenk Technology or Glove Box). All solvents required were flushed with argon before use and rendered absolute over molecular sieve. The polyethylene glycol star polymer used in Example 3 was obtained from Nektar Therapeutics, formerly Shearwater Polymers (Nektar Therapeutics, P.O. Box 2324, Birmingham, Ala. 35201, U.S.A). Abbreviations: PVAc denotes polyvinyl acetate, PVOH polyvinyl alcohol, and PVB polyvinyl butyral.

### EXAMPLE 1

ω-methoxypolyethylene glycol 2-iodo-2-methyl propionate

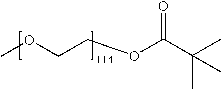

A 500 ml round-bottomed flask is charged with 21.5 g (4.3 mmol) of polyethylene is glycol monomethyl ether (M=5000 g/mol) in 100 ml of dichloromethane. At 0° C. 0.435 g (4.3 mmol) of triethylamine and then 1 g of 2-iodo-2-methylpropionyl chloride (D. N. Harpp et al., J. Org. Chem. 1975, 40, 3420-3427) are added dropwise. The solution is stirred at room temperature overnight and then washed with 100 ml of water and 50 ml of 2 M NaOH. The solvent is removed by drying over magnesium sulphate under reduced pressure, and the residue is dried under an oil pump vacuum, giving the product as a white solid. Yield: 19.34 g (3.7 mmol, 87%). ¹H-NMR (500 MHz, CDCl₃): δ=3.62 (m, about 520 H, PEG), 3.36 (s, 3H, PEG-OMe), 2.15 (s, 6H, C(CH₃)₂I) ppm.

### EXAMPLE 2

### Polymerization of a Vinyl Acetate with the Initiator of Example 1

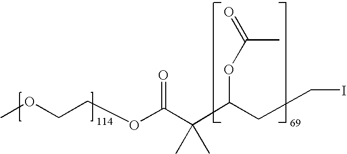

A 100 ml round-bottomed flask is charged in succession and under argon with the following reagents: 85 mg (0.24 mmol) of cyclopentadienyldicarbonyliron(I) dimer, 2.0 ml of anisol, 4.42 ml (48 mmol) of vinyl acetate, 2.5 g (0.48 mmol) of ω-methoxypolyethylene glycol 2-iodo-2-methyl-propionate and 0.96 ml (0.24 mmol, c=0.25 mol/l in anisol) of aluminium triisopropoxide. The solution is stirred at 70° C. for 18 hours. Then the solvent and residual monomer are removed at 70° C. under reduced pressure. The product is dissolved in 30 ml of methanol and filtered over Alox 90 N. It is washed in portions with a further 100 ml of methanol. The solvent is removed under reduced pressure, giving the product as a pale powder. Yield: 3.0 g. ¹H-NMR (500 MHz, CDCl₃): δ=4.85 (PVAc), 3.62 (PEG), 3.35 (PEG-OCH₃), 2.05-1.95 (PVAc), 1.90-1.63 (PVAc & OC(O)C(CH₃)₂PVAc) ppm. GPC: M₂=11.000 g/mol, Mₙ=8700 g/mol, M_{w}/Mₙ=1.27. DSC: Tₘ=54° C.

### EXAMPLE 3

### Tetrakis-p-iodomethylphenylmethyl-4-Star-PEG[10]

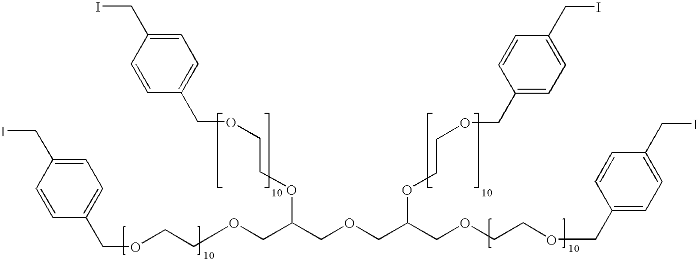

11.1 g (80 mmol) of potassium carbonate are cautiously baked in a 250 ml round-bottomed flask. Following the addition of 150 ml of dimethylformamide, 20 g (10 mmol) of Tetrakis-hydroxy-4-Star-PEG[10] (M_{w}=2000 Da, Nektar Therapeutics, # 0J000D04), and 28.6 g (80 mmol) of 1,4-bisiodomethylbenzene, the mixture is stirred at 120° C. for 72 hours. The solvent is distilled off under reduced pressure and the residue is taken up in 200 ml of dichloromethane and 100 ml 2 M hydrochloric acid. The aqueous phase is extracted with twice 100 ml of dichloromethane. The combined organic phases are dried over magnesium sulphate and the solvent is removed under reduced pressure. The product is purified by column chromatography (silica gel, mobile solvent 1:1 dichloromethane/methanol) and obtained as a white amorphous solid. Yield: 19.3 g (6.6 mmol, 66%). ¹H-NMR (500 MHz, CDCl₃); δ=7.07, 6.99 (2×d, aromatic H), 4.63 (s, CH₂O) 4.36 (s, CH₂l) 3.71-3.53 (m, PEG) ppm.

### EXAMPLE 4

### Polymerization of Vinyl Acetate with the Initiator of Example 3 and Purification of the Polymer to Tetrakis-PVAc-methylphenylmethyl-4-Star-PEG[10]

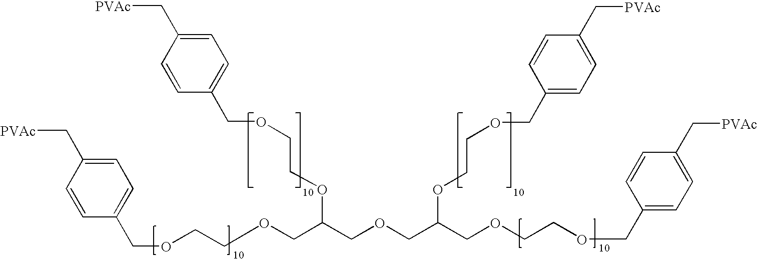

A 250 ml round-bottomed flask is charged in succession and under argon with the following reagents: 0.71 mg (2.0 mmol) of cyclopentadienyidicarbonyliron(I) dimer, 20 ml of anisol, 88.8 ml (960 mmol) of vinyl acetate, 2.92 g (1.00 mmol) of Tetrakis-p-iodomethylphenylmethyl-4-Star-PEG[10] and 8 ml (2 mmol, c=0.25 mol/l in anisol) of aluminium triisopropoxide. The solution is stirred at 70° C. for four hours. Thereafter the solvent and residual monomer are removed at 70° C. under reduced pressure. The reaction mixture is dissolved in 800 ml of acetone and added to 1.25 l of n-heptane.

The system is allowed to settle for an hour and then the supernatant n-heptane is decanted off. The dark brown polymer thus obtained is dried under reduced pressure for two hours and taken up again in 800 ml of acetone. The dark polymer solution is added dropwise, with vigorous stirring using a KPG stirrer, to 2 l of an ice/2 M hydrochloric acid mixture (1 kg ice/1 l 2 M HCl). The polymer powder obtained in this way is isolated by filtration, washed to neutrality with twice 250 ml of water and freeze-dried under reduced pressure. The polymer thus obtained is colourless and no longer contains anisol. Yield: 37 g. ¹H-NMR (500 MHz, CDCl₃): δ=4.93-4.81 (PVAc), 3.67-3.51 (PEG), 2.05-1.95 (PVAc), 1.93-1.68 (PVAc) ppm. GPC: M_{w}=37.000 g/mol, Mₙ=32.000 g/mol, M_{w}/Mₙ=1.16. DSC: Tₘ=36° C.

### EXAMPLE 5

### Preparation of Tetrakis-PVOH-methylphenylmethyl-4-Star-PEG[10]

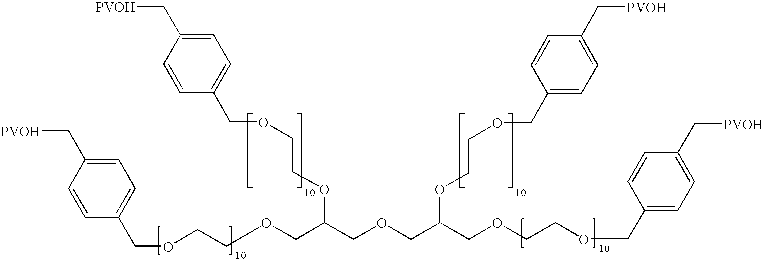

In a 250 ml round-bottomed flask 50 ml of a 1% strength methanolic sodium hydroxide solution are heated to 50° C. in a waterbath. Added dropwise to this solution over a period of 30 minutes is a solution of 5 g of Tetrakis-PVAc-methylphenylmethyl-4-Star-PEG[10] (Example 4) in 100 ml of methanol. After the end of the addition the system is stirred for 30 minutes. The white precipitate is isolated by filtration, washed alkali-free with methanol and dried under reduced pressure. Yield: 2.6 g. ¹H-NMR (500 MHz, [D₆]-DMSO): δ=6.83, 6.65 (2×s, aromatic H), 3.55-3.41 (PEG), 4.65, 4.46, 3.89, 3.84, 3.31, 1.44-1.33 (4×s, 1×m, PVOH) ppm. DSC: T_{g}=45° C., Tₘ=154° C.

### EXAMPLE 6

### Preparation of Tetrakis-PVB-methylphenylmethyl-4-Star-PEG[10]

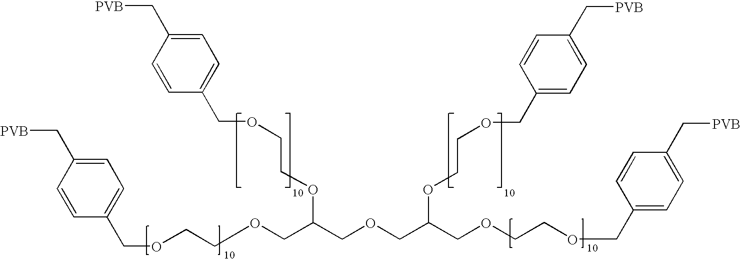

A 100 ml round-bottomed flask is charged with 1.7 g of n-butyraldehyde, and added dropwise to this is a solution, heated at 65° C., of 2.5 g of Tetrakis-PVOH-methylphenylmethyl-4-Star-PEG[10] (Example 5) in 25 ml of water/0.15 g of concentrated sulphuric acid, the dropwise addition being carried out over the course of 2 minutes. Following complete addition a further 0.5 g of concentrated sulphuric acid is added and the mixture is stirred at 55° C. for an hour. After cooling to room temperature, the precipitate is isolated by filtration and washed to neutrality with water. The polymer is dissolved in 25 ml of hot methanol and the solution is added to 100 ml of water. The polymer is isolated by filtration. Yield: 4.2 g. ¹H-NMR (500 MHz, [D₆]-DSMO): δ=6.87, 6.69 (2×s, aromatic H), 3.59-3.40 (PEG), 4.69 (m, CH), 4.63, 4.41, 3.81, 3.55, 3.31, 1.44-1.21 (PVOH & alkyl groups) ppm.

1-9. (canceled)

10. Polyvinyl polymer based on formulae IV, IVa and IVb 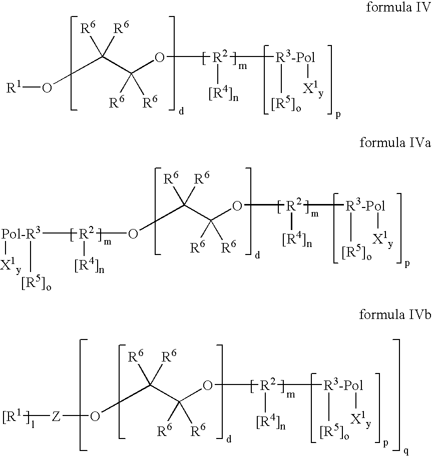
wherein
Z is a central atom and is an atom from groups 13 to 16 of the Periodic Table of the Elements or is an aromatic parent structure with at least four carbon atoms, in which one or more carbon atoms may be replaced by boron, nitrogen or phosphorus, wherein said aromatic parent structure is optionally substituted, or is a cyclic non-aromatic parent structure with at least three carbon atoms, which optionally contains at least one heteroatom,
X¹ is identical or different at each occurrence and is a halogen atom,
R¹ is identical or different and is hydrogen or a C₁-C₂₀ group, and
R² is identical or different and is a bridging C₁-C₂₀ group between the central atom Z and the initiating unit [R³-X¹] or silicon or oxygen, and
R³ is identical or different and is carbon or silicon, and
R⁴ is identical or different and is a hydrogen atom or a C₁-C₂₀ group, and
R⁵ is identical or different and is hydrogen or a C₁-C₂₀ group,
R⁶ is identical or different and is hydrogen or a C₁-C₂₀ group,
d is identical or different and is a whole natural number, and is a number between 5 and 100 000, and
l is a whole natural number and is zero, 1, 2, 3, 4, 5, 6, 7, 8, 9, 10, 11, 12, 13, 14, 15, 16, 17, 18, 19 or 20, and
m is identical or different at each occurrence and is a whole natural number, and is zero, 1, 2, 3, 4 or 5, and
n is identical or different at each occurrence and is a whole natural number, and is zero, 1, 2, 3, 4, 5, 6, 7, 8, 9, 10, 11, 12, 13, 14, 15, 16, 17, 18, 19 or 20, and
o is identical or different at each occurrence and is 1 or 2, and
p is identical or different at each occurrence and is a whole natural number, and is 1, 2, 3, 4 or 5, and
q is a whole natural number and is 3, 4, 5, 6, 7, 8, 9, 10, 11, 12, 13, 14, 15, 16, 17, 18, 19 or 20, and
y can be identical or different, and is zero or one, and
Pol is a homopolymer or copolymer based on a polyvinyl ester, a homopolymer or copolymer based on a polyvinyl alcohol or a homopolymer or copolymer based on a polyvinyl acetal.

11. The polymer as claimed in claim 10 wherein
R⁶ is identical or different and is hydrogen or methyl,
Z is carbon, silicon, nitrogen, phosphorus, oxygen or sulphur, or is an aromatic parent structure with at least four carbon atoms, in which one or more carbon atoms is optionally replaced by boron, nitrogen or phosphorus, wherein said aromatic or heteroaromatic parent structures are derived from benzene, biphenyl, naphthalene, anthracene, phenanthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, which optionally are substituted, or is a cyclic non-aromatic parent structure with at least three carbon atoms, which optionally contains as nitrogen, boron, phosphorus, oxygen or sulphur, and said cyclic non-aromatic parent structure is derivable from the cycloalkyl group, cycloheteroalkyl group, or from the saccharides group,
X¹ is identical or different at each occurrence and is fluorine, chlorine, bromine or iodine and
Pol is polyvinyl butyral.

12. The polymer as claimed in claim 11, wherein Z is a cyclic non-aromatic parent structure with at least three carbon atoms, which optionally contains as nitrogen, boron, phosphorus, oxygen or sulphur, and said cyclic non-aromatic parent structure is derivable cyclopropyl, cyclobutyl, cyclopentyl, cyclohexyl, cycloheptyl, cyclooctyl, cyclononyl, azididine, azetidine, pyrrolidine, piperidine, azepane, azocane, 1,3,5-triazinane, 1,3,5-trioxane, oxetane, furan, dihydrofuran, tetrahydrofuran, pyran, dihydropyran, tetrahydropyran, oxepane, oxocane, alpha-glucose or beta-glucose, and
X¹ is identical or different at each occurrence and is chlorine, bromine or iodine.

13. The polymer according to claim 10, wherein Pol is a polymer based on polyvinyl acetate or polyvinyl butyral.

14. The polymer according to claim 10, wherein Pol is a copolymer based on a polyvinyl ester with 1 or more 1-olefins having 4 to 20 carbon atoms.

15. The polymer according to claim 10, wherein Pol is a homopolymer based on polyvinyl acetate.

16. The polymer according to claim 10, wherein Pol is a copolymer based on a polyvinyl acetate with 1 or more 1-olefins having 4 to 20 carbon atoms.

17. A component which comprises the polymer as claimed in claim 10, wherein the component is an adhesive component, emulsifier, detergent, lubricant, coating component for electrically insulating magnetic wires, coating component for producing laminated glass sheets, an additive for motor fuels, an additive for engine oils, concrete, and additive in papermaking, an additive for producing water-soluble films and additive for preparing biodegradable and water-soluble polymers.

18. The component as claimed in claim 17, wherein the component is an adhesive primer or a textile coating.

19. An initiator system which comprises at least one initiator of formula I, Ia or Ib, at least one metal compound of formula II and optionally at least one additive of the formula III: 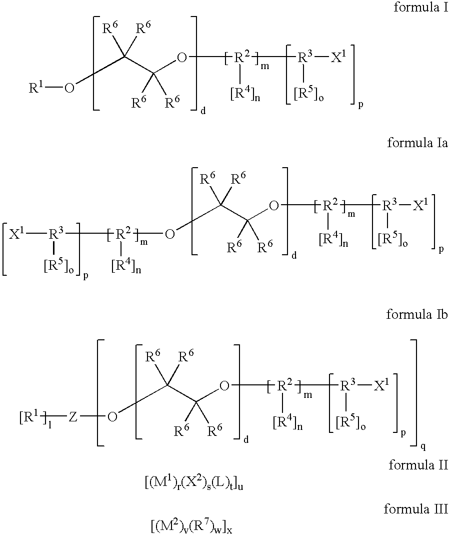
wherein
Z is a central atom and is an atom from groups 13 to 16 of the Periodic Table of the Elements or is an aromatic parent structure with at least four carbon atoms, in which one or more carbon atoms may be replaced by boron, nitrogen or phosphorus, wherein said aromatic parent structure is optionally substituted, or is a cyclic non-aromatic parent structure with at least three carbon atoms, which optionally contains at least one heteroatom,
X¹ is identical or different at each occurrence and is a halogen atom,
R¹ is identical or different and is hydrogen or a C₁-C₂₀ group, and
R² is identical or different and is a bridging C₁-C₂₀ group between the central atom Z and the initiating unit [R³-X¹] or silicon or oxygen, and
R³ is identical or different and is carbon or silicon, and
R⁴ is identical or different and is a hydrogen atom or a C₁-C₂₀ group, and
R⁵ is identical or different and is hydrogen or a C₁-C₂₀ group,
R⁶ is identical or different and is hydrogen or a C₁-C₂₀ group,
d is identical or different and is a whole natural number, and is a number between 5 and 100 000, and
l is a whole natural number and is zero, 1, 2, 3, 4, 5, 6, 7, 8, 9, 10, 11, 12, 13, 14, 15, 16, 17, 18, 19 or 20, and
m is identical or different at each occurrence and is a whole natural number, and is zero, 1, 2, 3, 4 or 5, and
n is identical or different at each occurrence and is a whole natural number, and is zero, 1, 2, 3, 4, 5, 6, 7, 8, 9, 10, 11, 12, 13, 14, 15, 16, 17, 18, 19 or 20, and
o is identical or different at each occurrence and is 1 or 2, and
p is identical or different at each occurrence and is a whole natural number, and is 1, 2, 3, 4 or 5, and
q is a whole natural number and is 3, 4, 5, 6, 7, 8, 9, 10, 11, 12, 13, 14, 15, 16, 17, 18, 19 or 20,
M¹ is identical or different at each occurrence and is a transition metal from groups 3 to 12 of the Periodic Table of the Elements,
X² is identical or different at each occurrence and is oxygen or a halogen atom,
L is identical or different at each occurrence and is a ligand,
r is identical or different at each occurrence and is a whole natural number, and is 1, 2, 3, 4 or 5, and
s is identical or different at each occurrence and is a whole natural number, and is zero, 1, 2, 3, 4 or 5, and
t is identical or different at each occurrence and is a whole natural number, and is zero, 1, 2, 3, 4 or 5, and
u is a whole natural number and is 1, 2, 3, 4 or 5, and
M² is identical or different and is an element from groups 1 to 15 of the Periodic Table of the Elements,
R⁷ is identical or different and is hydrogen, a halogen atom or a C₁-C₂₀ group,
v is identical or different and is a whole natural number, and is 1, 2, 3, 4, 5, 6, 7 or 8, and
w is identical or different and is a whole natural number, and is 1, 2, 3, 4, 5, 6, 7 or 8, and
x is a whole natural number and is 1, 2, 3, 4, 5, 6, 7 or 8.

20. The initiator system as claimed in claim 19, wherein
R⁶ is identical or different and is hydrogen or methyl,
Z is carbon, silicon, nitrogen, phosphorus, oxygen or sulphur, or is an aromatic parent structure with at least four carbon atoms, in which one or more carbon atoms is optionally replaced by boron, nitrogen or phosphorus, wherein said aromatic or heteroaromatic parent structures are derived from benzene, biphenyl, naphthalene, anthracene, phenanthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, which optionally are substituted, or is a cyclic non-aromatic parent structure with at least three carbon atoms, which optionally contains as nitrogen, boron, phosphorus, oxygen or sulphur, and said cyclic non-aromatic parent structure is derivable from the cycloalkyl group, cycloheteroalkyl group, or from the saccharides group,
X¹ is identical or different at each occurrence and is fluorine, chlorine, bromine or iodine,
M¹ is identical or different at each occurrence and is chromium, molybdenum, ruthenium, iron, rhodium, nickel, palladium or copper,
X² is identical or different at each occurrence and is oxygen, fluorine, chlorine, bromine or iodine,
L is identical or different at each occurrence and is a a carbon-containing ligand or a phosphorus-containing ligand,
M² is identical or different and is Li, Mg, Ti, B, Al, P or N, and
R⁷ is identical or different and is methoxy, ethoxy, n-propoxy or isopropoxy.

21. The initiator system as claimed in claim 20, wherein Z is a cyclic non-aromatic parent structure with at least three carbon atoms, which optionally contains as nitrogen, boron, phosphorus, oxygen or sulphur, and said cyclic non-aromatic parent structure is derivable cyclopropyl, cyclobutyl, cyclopentyl, cyclohexyl, cycloheptyl, cyclooctyl, cyclononyl, aziridine, azetidine, pyrrolidine, piperidine, azepane, azocane, 1,3,5-triazinane, 1,3,5-trioxane, oxetane, furan, dihydrofuran, tetrahydrofuran, pyran, dihydropyran, tetrahydropyran, oxepane, oxocane, alpha-glucose or beta-glucose,
X¹ is identical or different at each occurrence and is chlorine, bromine or iodine and
X² is identical or different at each occurrence and is oxygen, fluorine, chlorine, bromine or iodine,
L is identical or different at each occurrence and is methyl, phenyl, cymene, cumene, tolyl, mesityl, xylyl, indenyl, benzylidene, cyclopentadienyl or carbonyl, a nitrogen-containing ligand, such as triethylamine, tetramethylethylenediamine, pyridine, 2,2′-bipyridyl, substituted 2,2′-bipyridyl, 1,10-phenanthroline, phenylpyridin-2-yl-methylenamine, acetonitrile, substituted imidazolidine, terpyridyl, triphenylphosphine, tricyclohexylphosphine, bis(diphenylphosphino)ethane, bis(diphenylphosphino)propane or BINAP, and
M¹ is identical or different at each occurrence and is iron or ruthenium.

22. A process to produce the initiator system as claimed in claim 19 which comprises reacting the compound of the formula I, Ia or Ib with a metal compound of the formula II.

23. A process for preparing a polymer which comprises polymerizing vinyl esters with one or more initiator systems according to claim 20.

24. A process for purifying the polymer as claimed in claim 10, which comprises the following steps:
(A) reacting at least one compound of the formula I, Ia or Ib with at least one metal compound of the formula II, optionally in the presence of at least one additive of the formula III;
(B) concentrating the reaction mixture from step A) to remove residual monomer and solvents,
(C) dissolving the reaction mixture from step B) in one or more organic solvents;
(D) optionally oxidizing the catalyst present in the mixture, by stirring in the presence of atmospheric oxygen or addition of oxidizing agents;
(E) optionally separating off reaction products formed during the oxidization in step D);
(F) precipitating the polymer by adding the polymer solution to one or more apolar aprotic solvents, separating the supernatant solvent, and optionally drying the polymer obtained;
(G) optionally, redissolving the polymer obtained from step F) in one or more organic solvents,
(H) precipitating the polymer by adding the solution from step G) to water or to an aqueous solution of an acid or to an aqueous solution of a base, where appropriate with stirring and cooling,
(I) isolating the precipitated polymer, preferably by filtration or phase separation, optionally washing the polymer with water or with one of the liquids specified in step H),
(J) optionally repeating steps G), H) and I), and
(K) drying the polymer.
